(19) United States
(12) Patent Application Publication
(10) Pub. No.: US 2018/0062218 A1
(43) Pub. Date: Mar. 1, 2018

(54) ELECTRONIC DEVICE, CONTROL METHOD THEREFOR AND NON-TRANSITORY COMPUTER-READABLE STORAGE MEDIUM

(71) Applicant: CANON KABUSHIKI KAISHA, Tokyo (JP)

(72) Inventor: Shuya Kaechi, Hashimoto-shi (JP)

(21) Appl. No.: 15/684,151

(22) Filed: Aug. 23, 2017

(30) Foreign Application Priority Data
Aug. 24, 2016 (JP) 2016-164062

(51) Int. Cl. H01M 10/44; H02J 7/00; H02J 7/04

(52) U.S. Cl. CPC H01M 10/441; H02J 7/0031; H02J 2007/0096; H01M 2220/30; H02J 7/045

(57) ABSTRACT

An electronic device configured to be connected to an external device and to charge a secondary battery using power supplied from the external device determines whether the external device has a predetermined power supply capability, and, in a case where it is determined that the external device has the predetermined power supply capability, receives power from the external device at a predetermined current value and charges the secondary battery. The electronic device notifies a charge state of the secondary battery with a first notifying pattern, before it is determined whether the external device has the predetermined power supply capability, and notifies the charge state with a second notifying pattern in response to determining that the external device has the predetermined power supply capability.

### BACKGROUND OF THE INVENTION

### Field of the Invention

The present invention relates to an electronic device that receives power from an external device, a control method therefor and a non-transitory computer-readable storage medium.

### Description of the Related Art

Rechargeable secondary batteries are used as batteries for electronic devices. As means for charging a secondary battery, external charging that involves the secondary battery being removed from the electronic device and mounted in a dedicated charger to be charged is common. Also, in recent years, internal charging that involves charging of the secondary battery being performed inside the electronic device without removing the secondary battery from the electronic device has become common. With internal charging, a method that involves utilizing a USB (Universal Serial Bus) as an interface and charging the secondary battery provided inside the electronic device with power that is obtained from an external device connected via a VBUS line of the USB has become widely used.

In response to the demand for further improvement in power supply to electronic devices, utilization of power exceeding 2.5 W has been made possible by the formulation of standards such as USB 3.0, USB BC (Battery Charging) and USB PD (Power Delivery). According to these standards, an electronic device logically determines power and current that can be obtained from an external device that is connected, by means such as the voltage of a signal line, communication via the signal line and/or communication via the VBUS line.

The conditions under which power and current are suppliable differ between the abovementioned USB 3.0, USB BC and USB PD standards and erstwhile standards up to and including USB 2.0 that are already in widespread use. With the USB 2.0 standard, in particular, current on the USB VBUS line needs to be limited to less than 0.1 A until the electronic device has performed enumeration and determined the power supply capability of the external device. For example, in the case where the external device does not have power of 5 V/0.5 A, safe operation of the electronic device and the external device will be compromised when a current of 0.5 A is consumed from the VBUS line without enumeration. This is because a voltage drop on the VBUS line may occur due to the electronic device drawing a current of 0.5 A from the VBUS line, and the voltage on the VBUS line may fall below the minimum circuit operating voltage as a result of this voltage drop. In the case where the voltage on the VBUS line falls below the minimum circuit operating voltage, there is a possibility that charging will stop or that charging will repeatedly stop and start.

In order to prevent the occurrence of phenomena such as the above, the electronic device charges the secondary battery with power of less than 5 V/0.1 A before performing enumeration, and, after enumeration, charges the secondary battery in accordance with the power supply capability discriminated by the enumeration. In the case where the result of enumeration indicates that the current value suppliable by the external device is lower than the current value required by the electronic device, the electronic device ends the connection with the external device, and stops charging the secondary battery.

Japanese Patent Laid-Open No. 2009-60717 (hereinafter, Literature 1) describes a portable device in which a CPU starts up in the case where the output voltage of the secondary battery is greater than or equal to a startup voltage which is higher than the operating voltage. After startup, the CPU of the portable device switches the current drawn from an input terminal of the portable device from 100 mA to 500 mA, in response to detecting that a specific external device is connected to the input terminal, by executing a control program that is included in a boot program.

The portable device described in Literature 1 enables the charge time to be shortened, by the CPU detecting the connection destination after starting up, and switching the charge current of the secondary battery to a larger current value if a specific external device is detected.

Also, there are secondary batteries that are provided with an authentication IC for guaranteeing that the battery is an exclusively designed battery suited to the charging characteristics of the secondary battery. In the case of an electronic device using a secondary battery provided with an authentication IC, it is possible to operate the electronic device so as to perform authentication with the authentication IC, and to perform charging if the authentication IC can be authenticated normally and to stop charging for safety reasons if the authentication IC cannot be authenticated normally. For this reason, with such an electronic device, the charge state may change depending on the state of the secondary battery, before and after enumeration.

However, with the portable device described in Literature 1, it was difficult for a user to recognize a change in the charge state, in the case where charging of the secondary battery is stopped because of the connection destination not being a specific external device and the charging characteristics being unknown. For example, in the case where a charge lamp is not lighted, the user is not able to immediately judge whether charging has been completed or whether charging has been stopped because of the supply capability of the external device being insufficient or unknown.

### SUMMARY OF THE INVENTION

In one embodiment of the present invention, an electronic device that enables the charge state of a secondary battery to be notified more accurately is disclosed.

According to one aspect of the present invention, there is provided an electronic device configured to be connected to an external device and to charge a secondary battery using power supplied from the external device, comprising: a determination unit configured to determine whether the external device has a predetermined power supply capability; a charge control unit configured to receive power from the external device at a predetermined current value and charge the secondary battery, in a case where it is determined that the external device has the predetermined power supply capability; and a notification unit configured to notify a charge state of the secondary battery with a first notifying pattern, before it is determined whether the external device has the predetermined power supply capability, and to notify the charge state with a second notifying pattern corresponding to determining that the external device has the predetermined power supply capability.

According to another aspect of the present invention, there is provided a control method for an electronic device configured to be connected to an external device and to charge a secondary battery using power supplied from the external device, the method comprising: determining whether the external device has a predetermined power supply capability; receiving power from the external device at a predetermined current value and charging the secondary battery, in a case where it is determined that the external device has the predetermined power supply capability; and notifying a charge state of the secondary battery with a first notifying pattern, before it is determined whether the external device has the predetermined power supply capability, and notifying the charge state with a second notifying pattern corresponding to determining that the external device has the predetermined power supply capability.

According to another aspect of the present invention, there is provided a non-transitory computer-readable medium storing a computer program, the computer program causing a computer of an electronic device configured to be connected to an external device and to charge a secondary battery using power supplied from the external device to execute a method including: determining whether the external device has a predetermined power supply capability; receiving power from the external device at a predetermined current value and charging the secondary battery, in a case where it is determined that the external device has the predetermined power supply capability; and notifying a charge state of the secondary battery with a first notifying pattern, before it is determined whether the external device has the predetermined power supply capability, and notifying the charge state with a second notifying pattern corresponding to determining that the external device has the predetermined power supply capability.

Further features of the present invention will become apparent from the following description of exemplary embodiments (with reference to the attached drawings).

### BRIEF DESCRIPTION OF THE DRAWINGS

FIGS. 1A and 1B are flowcharts illustrating a charge operation by an electronic device according to a first embodiment.

FIG. 2 is a diagram showing a truth table of charge conditions and display patterns of the electronic device according to the first embodiment.

FIGS. 3A and 3B are block diagrams showing an exemplary configuration of the electronic device according to the first embodiment.

FIGS. 4A and 4B are flowcharts illustrating a charge operation by an electronic device according to a second embodiment.

FIG. 5 is a diagram showing a truth table of charge conditions and display patterns of the electronic device according to the second embodiment.

FIGS. 6A and 6B are block diagrams showing an exemplary configuration of the electronic device according to the second embodiment.

FIGS. 7A and 7B are flowcharts illustrating a charge operation by an electronic device according to a third embodiment.

FIG. 8 is a diagram showing a truth table of charge conditions and display patterns of the electronic device according to the third embodiment.

FIGS. 9A and 9B are block diagrams showing an exemplary configuration of the electronic device according to the third embodiment.

FIG. 10 is a block diagram showing an exemplary configuration of an electronic device according to a fourth embodiment.

### DESCRIPTION OF THE EMBODIMENTS

Hereinafter, embodiments of the present invention will be described with reference to the attached drawings. The embodiments of the present invention are, however, not limited to the following embodiments. Note that, in each of the following embodiments, a portable terminal such as a digital camera or a smart phone, for example, is given as the electronic device. Also, a PC (personal computer), a charging adapter or the like that is able to charge the electronic device using a USB interface is given as the external device. Also, hereinafter, whether the state of a signal is high level or low level is represented with H and L.

### First Embodiment

In a first embodiment, in the case where the voltage of a secondary battery of the electronic device is less than a threshold value, a charge condition limited to a safe current value is determined, regardless of a USB connection destination detection result for an external device that is connected, and display that depends on the determined charge condition is performed. In the case where the voltage of the secondary battery of the electronic device is greater than or equal to the threshold value, a charge condition is redetermined based on the USB connection destination detection result for the external device or the enumeration result, and display is performed in accordance with the redetermined charge condition.

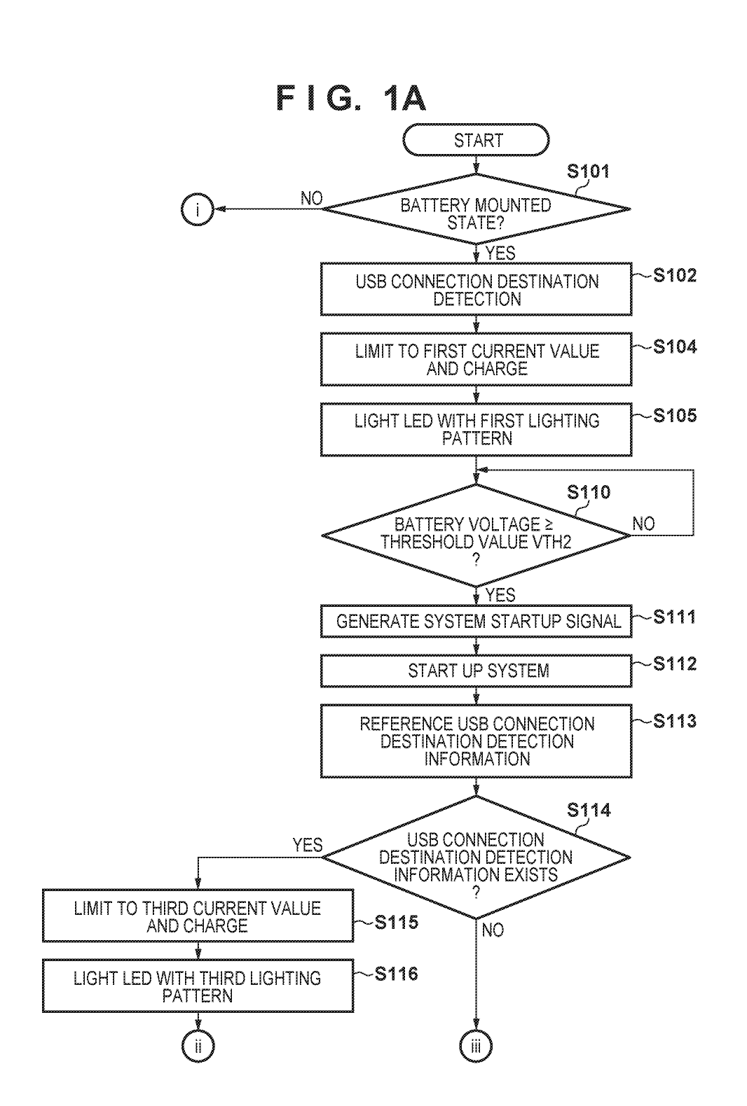

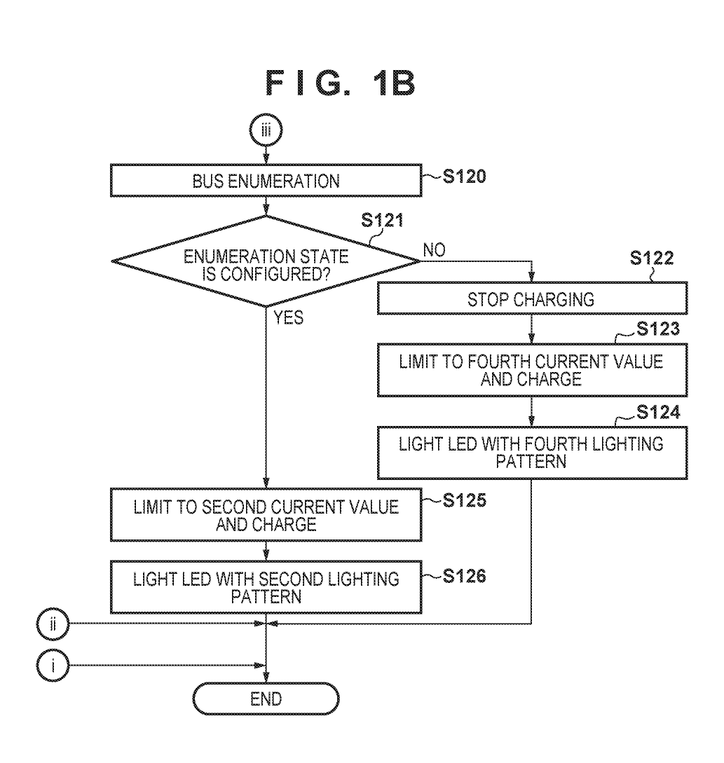

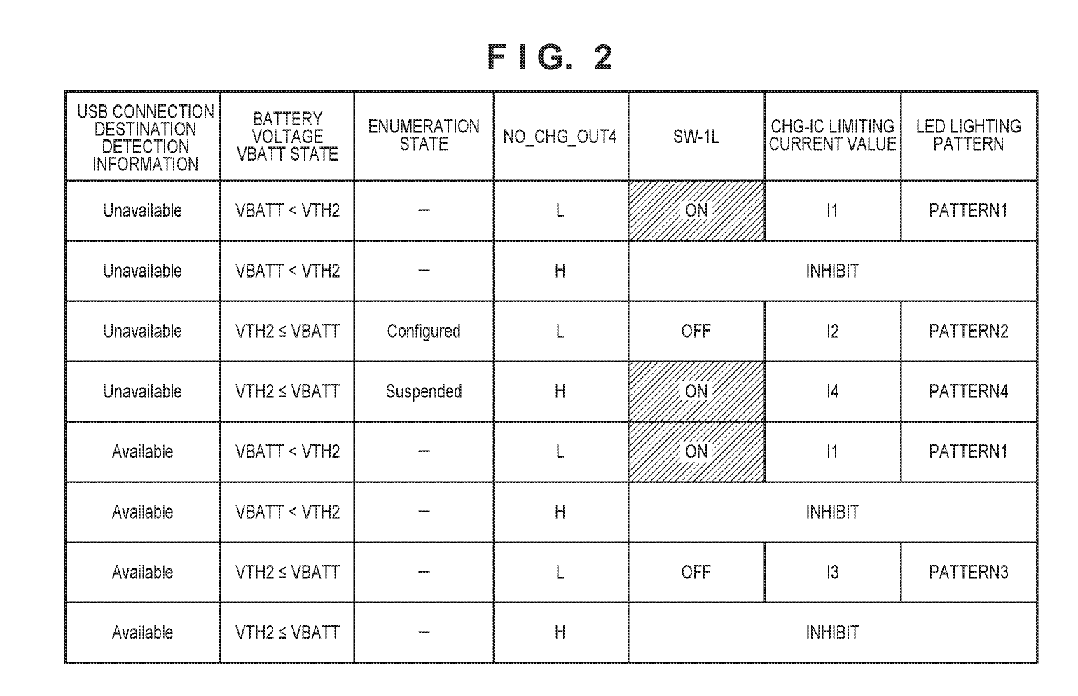

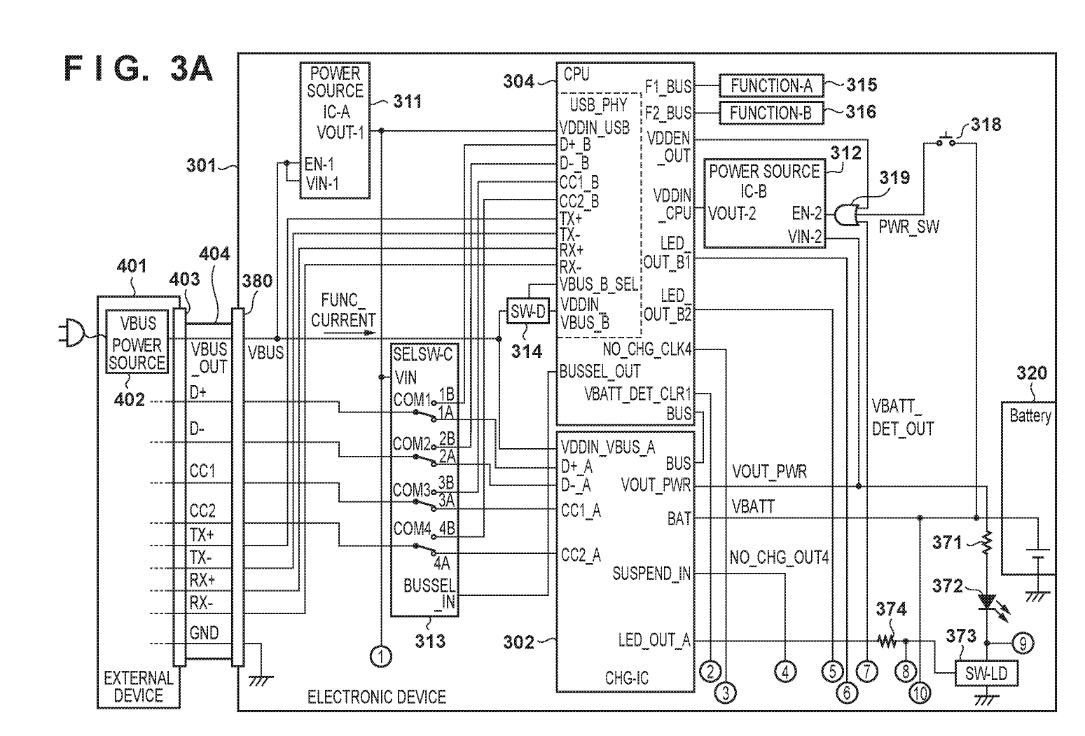

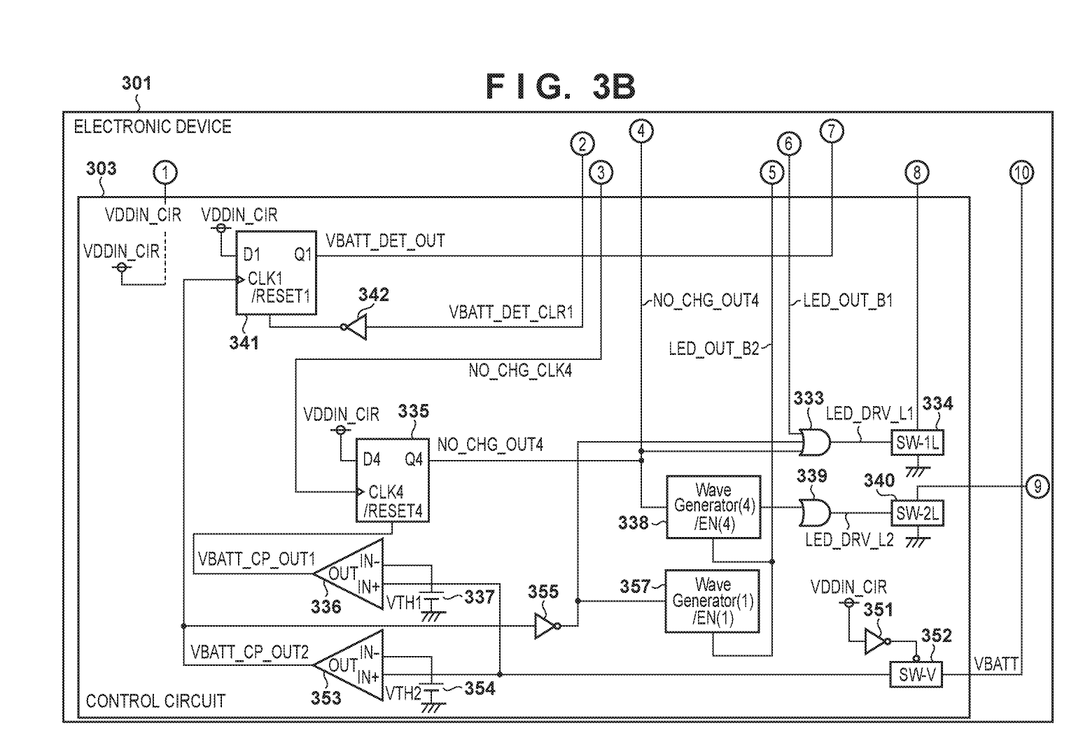

FIGS. 1A and 1B are flowcharts showing processing for determining a charge condition and displaying a charge state by the electronic device of the first embodiment. FIG. 2 is a truth table showing the correspondence between connection destination detection results, output voltages of the secondary battery, charge conditions (limiting current values) and display patterns (LED lighting patterns). FIG. 3A and FIG. 3B are block diagrams showing an exemplary configuration of the electronic device according to the first embodiment. First, the configuration of the electronic device according to the first embodiment will be described using FIG. 3A and FIG. 3B. Note that, in FIG. 3A and FIG. 3B, illustration of configuration that is unnecessary in the description of the present embodiment has been omitted.

In FIG. 3A, an external device 401 serving as a power transmission apparatus is capable of power supply by cable to an electronic device 301. The external device 401 may be an apparatus that is only capable of power supply, such as an adapter that is exclusively for charging, or an apparatus provided with functions other than power supply such as a personal computer. Also, the USB standard that is supported by the external device 401 may be any of USB 2.0, USB 3.0, USB 3.1, USB BC, and USB PD, for example.

A VBUS power source 402 is a power source that supplies power from the external device 401 to the electronic device 301. As power of the VBUS power source 402, power that is supplied from outside the external device 401 may be used, or power that is supplied from a battery provided inside the external device 401 may be used. A USB connector 403 is a connector that supports the USB standard. Note that the interfaces that connect the external device 401 and the electronic device 301 are not limited to USB, and may be interfaces of another standard. Also, because the various signals of USB interfaces are well known, a detailed description thereof is omitted. A USB interface cable 404 is a cable that connects the USB interfaces of the external device 401 and the electronic device 301.

The electronic device 301 is capable of receiving external power by cable from the abovementioned external device 401. A CPU 304 administers control of the electronic device 301. The CPU 304 contains memories such as a RAM (Random Access Memory) that is used as a work area and a ROM (Read Only Memory) that stores processing procedures. A main function of the CPU 304 operates on receipt of a voltage input VDDIN_CPU from outside. Also, a USB PHY of the CPU 304 operates on receipt of a voltage input VDDIN_USB from outside, and is operable separately from the main function. The USB PHY of the CPU 304 is able to operate with lower power than the power required in operation of the main function, and is provided with a USB connection destination detection function.

The USB connection destination detection function is a function for logically detecting whether the external device 401 connected to the electronic device 301 supports any of the USB standards, by means such as logic detection of VBUS, D+, D− and CC signals. The USB standards that are detected for include USB 2.0, USB 3.0, USB 3.1, USB BC, USB PD and USB Type-C, for example. Also, the USB connection destination detection function of the CPU 304 is able to determine types such as SDP, DCP, CDP as types of USB BC, 1.5 A current mode and 3.0 A current mode of USB Type-C, and the like. Here, SDP is short for Standard Downstream Port, DCP is short for Dedicated Charging Port, and CDP is short for Charging Downstream Port.

A CHG-IC 302 is a charge control IC capable of charging a battery 320. The CHG-IC 302 is capable of executing a function for receiving a voltage input VDDIN_VBUS_A from outside, and charging the battery 320. The CHG-IC 302 limits the current value (FUNCTION_CURRENT) that is input from the external device 401 via the VBUS with a limiting current value determined based on at least one of the voltage of the battery 320 and the charge capability of the external device 401. Specifically, the CHG-IC 302 sets the limiting current value, by operating an electronic circuit such as a variable resistor of a circuit within the CHG-IC 302. Note that electric charge that the CHG-IC 302 is capable of supplying to the battery 320 increases the larger the current value that is input to the CHG-IC 302 from the external device 401 via the VBUS. Accordingly, the efficiency (charge efficiency) with which the CHG-IC 302 charges the battery 320 is higher the higher the limiting current value.

Furthermore, the CHG-IC 302 is capable of respectively executing a function for converting a voltage input VDDIN_VBUS_A into a constant voltage output VOUT_PWR and outputting the voltage output to a power source IC-B 312, a function for receiving an output voltage (VBATT) of the battery 320 in the case where there is no voltage input VDDIN_VBUS_A, converting the output of the battery 320 to VOUT_PWR and outputting the voltage output, and a USB connection destination detection function.

Note that the USB connection destination detection function of the CHG-IC 302 is similar to the USB connection detection function of the CPU 304. Also, the CHG-IC 302 is connected to the CPU 304 with a BUS. The CPU 304, by communication with the CHG-IC 302 via the BUS, obtains the state of the CHG-IC 302 and controls the CHG-IC 302.

The battery 320 is, for example, a single cell lithium-ion secondary battery that is removable from the electronic device 301. A power source IC-A 311 converts a voltage input VIN-1 from outside into a constant voltage output VOUT-1, and outputs the voltage output to the CPU 304. In the power source IC-A 311, ON and OFF of the output VOUT-1 is controlled by a control signal EN-1 from outside. The power source IC-B 312 converts a voltage input VIN-2 from outside into a constant voltage output VOUT-2, and provides the voltage input VDDIN_CPU of the CPU 304. In the power source IC-B 312, ON and OFF of the output VOUT-2 is controlled by a control signal EN-2 from outside.

A LED (Light Emitting Diode) 372 is an example of a notification apparatus that is controlled so as to be lighted with a lighting pattern that depends on the limiting current value, and is for notifying the charge state to the user. The notification apparatus is not limited to an LED and need only be a device that executes notification processing that depends on the charge state. Note that the lighting patterns are, for example, means for temporally controlling lighting and extinguishing of the LED. Given that the limiting current value is determined based on at least one of the voltage of the battery 320 and the charge capability of the external device 401, the LED 372 can also be said to be lighted with a lighting pattern that is based on at least one of the voltage of the battery 320 and the charge capability of the external device 401. Also, instead of the LED 372, the notification apparatus may be an audio output apparatus that notifies the charge state to the user with an audio pattern that depends on the limiting current value. In the present embodiment, the LED 372 is lighted with lighting patterns set in advance with respect to limiting current values.

A SELSW-C 313 is a selector switch that switches a connection of the signals that are used in USB connection destination detection between a connection for supplying power to the CPU 304 and a connection for supplying power to the CHG-IC 302. Switching of the connection by the SELSW-C 313 is performed using a BUSSEL_IN signal. In an initial state, a connection is established such that the signals to be used in USB connection destination detection are supplied to the CHG-IC 302, and USB connection destination detection is performed by the CHG-IC 302. Note that because USB connection destination detection according to the present embodiment is also possible with the CPU 304, a configuration may be adopted in which a connection is established such that the signal to be used in USB connection destination detection is supplied to the CPU 304 in the initial state, and the CPU 304 performs USB connection destination detection.

The SW-D314 is a switch that switches the VBUS input from the external device between ON and OFF of the connection to the USB function of the CPU 304 (connection to VDDIN_VBUS_B). The USB connector 380 is a connector that supports the USB standard. The USB connector 380 is not limited to the connector configuration of the electronic device 301. Also, since the various signals of a USB interface are well known, description thereof is omitted.

A FUNCTION-A 315 can, in the case where the electronic device 301 is a digital camera, be configured as an image capturing functional unit constituted by an optical unit that is constituted by a lens, a system for driving the lens, an image sensor, an image capturing procedure unit that converts video captured with the image sensor into digital data, and the like. Also, a FUNCTION-B 316 can, for example, be configured as a display functional unit that is constituted by an LCD (Liquid Crystal Display) that is able to display operating information, video and the like of the electronic device 301. Of course, both the FUNCTION-A 315 and the FUNCTION-B 316 are not limited to the abovementioned functions or configurations, and the number of functional units is also not limited to the abovementioned examples.

A button switch 318 is a power switch for turning on the power source IC-B 312 of the electronic device 301, and operating the main function of the CPU 304 of the electronic device 301. A VBATT signal and a PWR_SW signal are activated when the button switch 318 is pressed. That is, in the case where the button switch 318 is pressed, the button switch 318 outputs the PWR_SW signal to other circuits. The PWR_SW signal, a VDDEN_OUT signal of the CPU 304 and a VBATT_DET_OUT signal of a control circuit 303 are OR-connected with an OR 319, and the power source IC-B 312 can be turned ON with input of any of these signals. Note that another form of switch may, needless to say, be used instead of the button switch 318.

The control circuit 303 (FIG. 3B) is a circuit that mainly controls display at the time of charging the battery 320. A power source VDDEN_CIR of the entire control circuit 303 is obtained from the output VOUT-1 of the power source IC-A 311. Accordingly, power will be constantly supplied in the case where the VBUS of the external device 401 is connected. In the case where supply is started in a state where the power source VDDIN_CIR is not being supplied to the control circuit 303, the logic of each circuit of the control circuit 303 which will be described below is set to the initial state, and the functions are negated. Also, in the case where supply is stopped in a state where the power source VDDIN_CIR is being supplied to the control circuit 303, the functions of each circuit of the control circuit 303 which will be described below are negated.

A SW-V 352 is an element that enters a conduction state when ON and enters a high impedance state when OFF, and is constituted by, for example, a PNP transistor or a P-Ch MOSFET. In the case where the VDDIN_CIR is being supplied, the output of an inverter 351 is L. The output of the inverter 351 is connected to the input of the SW-V 352, and the SW-V 352 will be OFF when output of the inverter 351 is H and will be ON when output of the inverter 351 is L.

The output voltage VBATT of the battery 320 is supplied to an IN+ input of a comparator 336 and a comparator 353 via the SW-V 352. Supply of the voltage VBATT to the IN+ input of the comparator 336 and the comparator 353 is turned ON/OFF in accordance with ON/OFF of the SW-V 352. Also, a reference voltage 337 (VTH1) is supplied to an IN− input of the comparator 336. A reference voltage 354 (VTH2) is supplied to an IN− input of the comparator 353. Note that VTH2≧VTH1. The comparator 336 and the comparator 353 compare the IN+ input and the IN− input, and output H in the case where the IN+ input signal is larger and output L in the case where the IN− input signal is larger.

The output (VBATT_CP_OUT2) of the comparator 353 is supplied to a CLK1 input of a D-FF 341 and the input of the inverter 355. The output of the inverter 355 is connected to an OR 333 and a WaveGenerator(1) 357. A D1 input of a D-FF 341 is connected to the VDDIN_CIR, and a Q1 output (VBATT_DET_OUT) is connected to the input of the OR 319. A /RESET1 input of the D-FF 341 is connected to the output of an inverter 342. If the power source VDDIN_CIR of the control circuit 303 is being supplied, and VBATT is greater than or equal to VTH2 of the reference voltage 354 of the comparator 353, the CLK1 input of the D-FF 341 transits from L to H, and a VBATT_DET_OUT signal transits from L to H.

As a result of this VBATT_DET_OUT signal, the output VOUT-2 of the power source IC-B 312 turns ON and the CPU 304 turns ON. The CPU 304, having turned ON, executes predetermined software, and outputs a VBATT_DET_CLR1 signal at H and thereafter at L. Since the VBATT_DET_CLR1 signal is inverted with the inverter 342, L is input to the /RESET1 input of the D-FF 341 as a result of the VBATT_DET_CLR1 signal changing to H, and the state of the D-FF 341 is reset. Upon the state of the D-FF 341 being reset, the VBATT_DET_OUT signal transits from H to the initial state of L. Thereafter, upon the VBATT_DET_CLR1 signal being changing to L, H is input to the /RESET1 input of the D-FF 341, and the D-FF 341 waits for the next state (waits for CLK1 to next change to H).

The output (VBATT_CP_OUT1) of the comparator 336 is connected to a /RESET4 input of a D-FF 335. The power source VDDIN_CIR of the control circuit 303 is supplied to a D4 input of the D-FF 335. Because the /RESET4 input is H if the output voltage VBATT of the battery 320 is greater than or equal to VTH1 of the reference voltage 337, the D-FF 335 waits for the next state (waits for CLK4 to next change to H). If the output voltage VBATT of the battery 320 is less than VTH1 of the reference voltage 337, the output of the comparator 336 changes to L, the /RESET4 input of the D-FF 335 changes to L, and the state of the D-FF 335 is reset.

The D4 input of the D-FF 335 is connected to VDDIN_CIR, and a Q4 output (NO_CHG_OUT4) is supplied to SUSPEND_IN of the CHG-IC 302 and used in VBUS input current control of the CHG-IC 302. NO_CHG_OUT4 is additionally connected to the OR 333 and a WaveGenerator 338 which will be discussed later.

A CLK4 input of the D-FF 335 is connected to NO_CHG_CLK4 of the CPU 304. In the case where, after the CPU 304 turns ON, the CPU 304 determines to stop charging, the CPU 304 outputs NO_CHG_CLK4 at H and thereafter at L. Upon NO_CHG_CLK4 transiting from L to H, the NO_CHG_OUT4 signal that is output from Q4 of the D-FF 335 transits from L to H. The CHG-IC 302 controls the limiting current value to be a current value I4 (2.5 mA; suspension current of USB standard) upon NO_CHG_OUT4 changing to H. In the present embodiment, the suspension current of the USB standard is used as the current value I4, but the present invention is not limited thereto.

The output of the inverter 355, the NO_CHG_OUT4 signal, and an LED_OUT_B1 signal of the CPU 304 are connected to the input of the OR 333. The output (LED_DRV_L1 signal) of the OR 333 is supplied as a control signal of a SW-1L 334. The SW-1L 334 is an element that enters a conduction state when ON and enters a high impedance state when OFF, and is constituted by, for example, an NPN transistor, an N-Ch MOSFET or the like.

The SW-1L 334 connects LED_OUT_A of the CHG-IC 302 to GND via a resistor 374. Also, the SW-1L 334 is connected to the input of a SW-LD 373. The SW-LD 373 is an element that enters a conduction state when ON and enters a high impedance state when OFF, and is constituted by, for example, an NPN transistor, an N-Ch MOSFET or the like. An anode of the LED 372 is connected to VOUT_PWR via a resistor 371, and a cathode of the LED 372 is connected to GND via the SW-LD 373. Accordingly, ON/OFF of current flowing to the LED 372 is controlled, by output of the LED_OUT_A signal of the CHG-IC 302, and lighting/extinguishing of the LED 372 is controlled. The LED 372 is used as a display device that shows the charge operating state of the electronic device 301.

In the case where the signal of any of the inputs of the OR 333 is H, the LED_DRV_L1 signal changes to H and the SW-1L 334 turns ON. Upon the SW-1L 334 turning ON, the LED_OUT_A signal of the CHG-IC 302 is connected to GND via the resistor 374, and the control input of the SW-LD 373 is thereby connected to GND. Thus, the LED 372 maintains the extinguished state, and control of the LED 372 using output of the LED_OUT_A signal of the CHG-IC 302 will be invalidated.

The WaveGenerator 357 and the WaveGenerator 338 are rectangular wave generating circuits that have an arbitrary output cycle of H and L, for example. The WaveGenerator 357 outputs a signal for lighting/extinguishing the LED 372 with a first lighting pattern which will be discussed later. The WaveGenerator 338 outputs a signal for lighting/extinguishing the LED 372 with a fourth lighting pattern which will be discussed later. Validation and invalidation of the signal outputs of the WaveGenerator 357 and the WaveGenerator 338 are respectively controlled with input of /EN1 and /EN4. A LED_OUT_B2 signal of the CPU 304 is connected to the /EN1 input of the WaveGenerator 357 and the /EN4 input of the WaveGenerator 338. Accordingly, the CPU 304 is able to control validation/invalidation of the signal outputs of the WaveGenerator 357 and the WaveGenerator 338. A configuration may be adopted in which, during software operation of the CPU 304, the LED_OUT_B2 signal is controlled to be H, the signal outputs of the WaveGenerator 357 and the WaveGenerator 338 are invalidated, and charge state display is performed with the FUNCTION-B 316.

Note that the LED_OUT_B2 signal of the CPU 304 is given to be L in the case where the output VOUT-2 of the power source IC-B 312 is OFF, and that the initial value of the LED_OUT_B2 signal is given to be L in the case where the output VOUT-2 of the power source IC-B 312 of the CPU 304 is ON. Also, the signal output cycles of the WaveGenerator 357 and the WaveGenerator 338 and the periods of H and L may both differ, or the signal output cycles may be the same and the periods of H and L may differ. Also, the WaveGenerator 357 and the WaveGenerator 338 are not limited to a rectangular wave generating circuit. For example, any of a buffer circuit that directly outputs input signals, a sine wave generating circuit, a triangular wave generating circuit and a sawtooth wave generating circuit may be used.

In the present embodiment, the WaveGenerator 357 is given as periodically generating and outputting a rectangular wave that switches between H and L every 0.5 sec. Also, the WaveGenerator 338 is given as periodically generating and outputting a rectangular wave that is output at H for 0.5 sec and then output at L for 1.0 sec.

The output of the WaveGenerator 357 and the output of the WaveGenerator 338 are connected to the input of an OR 339. The output (LED_DRV_L2 signal) of the OR 339 is supplied to the input of a SW-2L 340. The SW-2L 340 is an element that enters a conduction state when ON and enters a high impedance state when OFF, and is constituted by, for example, an NPN transistor, an N-Ch MOSFET or the like. The SW-2L 340 switches the connection between the cathode of the LED 372 and GND. As a result, ON/OFF of current flowing to the LED 372 is controlled by output of the LED_DRV_L2 signal, and lighting/extinguishing of the LED 372 is controlled.

In the present embodiment, two systems of signals for controlling lighting and extinguishing of the LED 372 exist, namely, the LED_OUT_A signal of the CHG-IC 302 and the LED_DRV_L2 signal of the control circuit 303. The signal of one of the inputs of the OR 333 changes to H to invalidate control of the LED 372 by the LED_OUT_A signal output of the CHG-IC 302, such that lighting/extinguishing of the LED 372 by the signals of those circuits do not interfere with each other. Control of the LED 372 is validated, using output of LED_DRV_L2 signal of the control circuit 303. In this way, exclusive control of lighting and extinguishing of the LED 372 with respect to the above two systems of signals is desirable.

Hereinabove, the configuration of the electronic device 301 of the present embodiment was described, using FIG. 3A and FIG. 3B. Next, the procedure by which the electronic device 301 according to the first embodiment performs USB connection destination detection and starts charging the battery 320, and also controls the lighting pattern of the LED 372 will be described, with reference to FIGS. 1A and 1B. Note that although USB connection destination detection can be executed with either the CHG-IC 302 or the CPU 304, hereinafter description will be given with USB connection destination detection being performed by the CHG-IC 302.

Upon the battery 320 being mounted in the electronic device 301 and the external device 401 being connected to the USB connector 380 (YES at step S101), the CHG-IC 302 executes USB connection destination detection (step S102). In USB connection destination detection of the present embodiment, it is determined whether the USB connection destination power transmission apparatus (external device 401) is a USB BC, USB PD or 1.5 A or 3.0 A USB Type-C compatible apparatus. The determination result is recorded in a register within the CHG-IC 302, for example.

Upon ending USB connection destination detection, the CHG-IC 302 starts charging the battery 320 with the limiting current value set to a current value I1, irrespective of the result of USB connection destination detection (step S104). Here, the current value I1 is set to 0.1 A. In the present embodiment, as described above, the CHG-IC 302 sets the limiting current value to the current value I1 in the initial state and charges the battery. Also, the limiting current value and the charge setting of the CHG-IC 302 can be changed under control of the CPU 304 that uses communication using the BUS. In the control circuit 303, since VBATT_CP_OUT2 will be L while the output voltage VBATT of the battery 320 is less than the threshold value VTH2, the LED 372 is lighted/extinguished with the signal pattern that is output from the WaveGenerator 357 (first lighting pattern (hereinafter, lighting pattern P1)). As abovementioned, the signal that is output with the WaveGenerator 357 is a rectangular wave that is alternately output at H and L for equal periods. Accordingly, based on the lighting pattern P1, the LED 372 whose lighting is controlled flashes repeatedly at a 1.0 sec cycle. By thus lighting/extinguishing the LED 372 with the lighting pattern P1, it is notified that the charge state is a charge state in which the limiting current value is the current value I1 (step S105).

Charging limited to the current value I1 is implemented until the output voltage (VBATT) of the battery 320 becomes greater than or equal to the threshold value VTH2 (NO at step S110). The determination of whether the output voltage (VBATT) of the battery 320 is greater than or equal to the threshold value VTH2 is performed with the comparator 353 of the control circuit 303. The threshold value VTH2 is the voltage at which hardware operation of the power source IC-B 312 and the CPU 304 of the electronic device 301, software operation of the CPU 304, and operation of the main function of the CPU 304, the FUNCTION-A 315 and the FUNCTION-B 316 are possible.

Upon the output voltage (VBATT) of the battery 320 becoming greater than or equal to the threshold value VTH2, the control circuit 303 generates a system startup signal (step S111), and starts up the system (step S112). In the present embodiment, the system startup signal is the VBATT_DET_OUT signal of the control circuit 303. Also, in system startup, hardware and predetermined software of the CPU 304 is started up, and the CPU 304 outputs a VDDEN_OUT signal to maintain the output of the power source IC-B 312. The VBATT_DET_OUT signal of the control circuit 303 is then reset with the VBATT_DET_CLR1 signal.

Next, the CPU 304, upon the output voltage VBATT of the battery 320 becoming greater than or equal to the predetermined threshold value VTH2, determines whether the external device has a predetermined power supply capability. In the present embodiment, reference to the result of USB connection destination detection and determination by enumeration are used. First, the CPU 304 refers to the USB connection destination detection information detected at step S102 (step S113). In the present embodiment, since the CHG-IC 302 performs USB connection destination detection, the CPU 304 obtains USB connection destination detection information from the CHG-IC 302 by communication using the BUS. In the case where USB connection destination detection information could be obtained, the CHG-IC 302 sets the limiting current value to the current value I3 and continues charging the battery 320 (YES at step S114; step S115). In the present embodiment, the CPU 304 sets the limiting current value of the CHG-IC 302 to a current value I3, by communication using the BUS, and configures the settings for charging the battery under the limitation thereof. Note that although the current value I3 is given as 0.5 A in the present embodiment, the current value I3 is not limited to 0.5 A, and may be any current value that does not exceed the current value that is supported by the external device 401 that is identified in accordance with the result of USB connection destination detection information.

The case where there is USB connection destination detection information of the present embodiment is given as the case where the connected external device 401 is a USB BC, USB PD or 1.5 A or 3.0 A USB Type-C compatible apparatus. Also, the case where there is no USB connection destination detection information is given as the case where the connection power transmission apparatus is not a USB BC, USB PD or 1.5 A or 3.0 A USB Type-C compatible apparatus or where the connection destination is unknown. Note that the case where there is no USB connection destination detection information also includes the case where the external device 401 is an SDP (Standard Downstream Port).

Next, the CPU 304 controls the LED 372 so as to be lighted with a third lighting pattern (hereinafter, lighting pattern P3) to display the charge state (step S116), and ends the flowcharts of FIGS. 1A and 1B. With the setting of the lighting pattern P3, the CPU 304 sets the lighting pattern of the CHG-IC 302 with communication using the BUS, and a signal pattern is generated from the LED_OUT_A signal of the CHG-IC 302. For example, the lighting pattern P3 is given to be a lighting pattern that keeps the LED 372 lighted. Note that, at this time, the CPU 304 sets LED_OUT_B2 to H and invalidates the WaveGenerator 338 and the WaveGenerator 357. Also, at this point in time, since the output (VBATT_CP_OUT) of the comparator 353 is H, the output of the inverter 355 is L, and the output (NO_CHG_OUT4) of the D-FF 335 is also L. Therefore, the CPU 304 sets LED_OUT_B1 to L, sets the output (OR_DRV_L1) of the OR 333 to L, and turns OFF the SW-1L 334. As a result, the LED 372 is lighted/extinguished in accordance with the LED_OUT_A signal of the CHG-IC 302.

On the other hand, in the case where there is no USB connection destination detection information, the CPU 304 performs bus enumeration by D+ and D− signals with the USB connection destination power transmission apparatus using the USB PHY (NO at step S114; step S120). The CPU 304 then determines whether the result of bus enumeration indicates that the state is Configured (step S121).

In bus enumeration, the CPU 304 of the electronic device 301 conveys the VBUS maximum current value with a configuration descriptor to the external device 401 that is connected by USB. In the case where the VBUS maximum current value conveyed to the external device 401 can be permitted, the Configured state is entered. Conversely, in the case where the VBUS maximum current value conveyed to the external device 401 cannot be permitted, the Configured state is not entered. In the present embodiment, the following description will be given with the VBUS maximum current value as a current value I2 (0.5 A).

In the case where the result of enumeration indicates that the state is Configured (i.e., in the case where the power supply capability of the external device could be determined), the CHG-IC 302 continues charging the battery 320 with the limiting current value set to the current value I2 (YES at step S121; step S125). In the present embodiment, the CPU 304 is given as setting the limiting current value of the CHG-IC 302 to the current value I2 with communication using the BUS, and configuring settings for charging the battery 320 under the limitation thereof. Here, the current value I2 is given as 0.5 A. Note that the current value I2 is not limited to 0.5 A, and may be any current value that does not exceed the VBUS maximum current value of the configuration descriptor.

Next, the electronic device 301 controls the LED 372 so as to be lighted with a second lighting pattern (hereinafter, lighting pattern P2) to display the charge state (step S126). Lighting of the LED 372 with the lighting pattern P2 is implemented using the LED_OUT_A signal of the CHG-IC 302. The CPU 304 sets the lighting pattern of the CHG-IC 302 to the lighting pattern P2 with communication using the BUS. For example, the lighting pattern P2 is given as a lighting pattern that keeps the LED 372 lighted, similarly to the lighting pattern P3. Note that the lighting pattern P2 may be configured to differ from the lighting pattern P3. Similarly to step S116, in order to light/extinguish the LED 372 in accordance with the LED_OUT_A signal of the CHG-IC 302, the WaveGenerator 338 and the WaveGenerator 357 are invalidated, and the SW-1L 334 is controlled to be OFF.

In the case where the result of enumeration indicates that the state is not Configured, the CPU 304 stops charging the battery 320 using power of the external device 401 that is from the VBUS (NO at step S121; step S122). In the present embodiment, the CPU 304 stops the function for charging the battery 320 by the CHG-IC 302 with communication using the BUS (step S122). The CPU 304 then sets the limiting current value to the current value I4 (step S123).

In the present embodiment, in response to the result of enumeration indicating that the state is not Configured, the CPU 304 outputs NO_CHG_CLK4 at H and thereafter at L. The NO_CHG_OUT4 signal, which is the output of the D-FF 335 of the control circuit 303, is thereby set to H, and the SUSPEND_IN input of the CHG-IC 302 is controlled to be H. Upon the SUSPEND_IN input of the CHG-IC 302 being controlled to be H, the CHG-IC 302 sets the limiting current value to the current value I4.

Note that the CPU 304 may be configured to set the limiting current value of the CHG-IC 302 to the current value I4 with communication using the BUS. Also, although the current value I4 is given as I4=2.5 mA, the current value I4 is not limited to 2.5 mA, and a configuration may be adopted in which the current value is changed depending on the result of enumeration. For example, the CHG-IC 302 may set the current value I4 to 2.5 mA in the case where enumeration could be implemented but the Configured state was not entered, and may set the current value I4 to 0.1 A in the case where enumeration could not be implemented. Note that although charging of the battery 320 is stopped in the present embodiment, a configuration may be adopted in which charging of the battery 320 is continued in a state of being limited to the current value I4.

The electronic device 301 lights the LED 372 with the fourth lighting pattern (hereinafter, lighting pattern P4), and displays the charge state (step S124). The signal pattern for the lighting pattern P4 is generated with the WaveGenerator 338 of the control circuit 303. As mentioned above, the WaveGenerator 338 periodically outputs a rectangular wave that is output at H for 0.5 sec and then at L for 1.0 sec. Accordingly, the LED 372 whose lighting is controlled with the lighting pattern P4 repeatedly flashes with the extinguished period being longer than the lighted period. The lighting pattern P4 is a different lighting pattern from the abovementioned lighting patterns P1 to P3. Also, in the present embodiment, the LED_OUT_A signal of the CHG-IC 302 is invalidated by the CPU 304 setting LED_OUT_B1 to H. Since VBATT_CP_OUT is H and NO_CHG_OUT4 is H, the output of the WaveGenerator 338 is output as LED_DRV_L2 from the OR 339 when the CPU 304 sets LED_OUT_B2 to L. The LED 372 is lighted/extinguished in accordance with H/L of LED_DRV_L2.

In the case where charging of the battery 320 is completed after continuing charging in the determined charge state as described above, the CHG-IC 302 controls lighting of the LED 372 with a lighting pattern P5. For example, the lighting pattern P5 is given as a lighting pattern that keeps the LED 372 extinguished. The lighting pattern P5 is a different lighting pattern from at least the lighting pattern P4.

After the end of the flowcharts of FIGS. 1A and 1B, the electronic device 301 may continue the software operation by the CPU 304 or may end the software operation by the CPU 304.

The truth table of FIG. 2 shows limiting current values and lighting patterns of the LED 372 corresponding to the USB connection destination detection information of the electronic device 301, the voltage VBATT state of the battery 320, the enumeration state, the NO_CHG_OUT4 signal and the state of the SW-1L 334. In the truth table of FIG. 2, combinations that cannot be taken as a signal combination are given as INHIBIT. Also, the case where there is no USB connection destination detection information is represented as Unavailable, and the case where there is USB connection destination detection information is represented as Available. Also, the state in the case where the result of bus enumeration indicates Configured is represented as Configured, and the state in the case where the result of bus enumeration does not indicate Configured is represented as Suspended.

First, the case where the USB connection destination detection information in the truth table of FIG. 2 is Unavailable will be described. Since the CPU 304 has not yet started up and bus enumeration has not been performed in the case where the output voltage VBATT of the battery 320 is less than VTH2, the enumeration state is BLANK. If the enumeration state is BLANK, the NO_CHG_OUT4 signal is L and the SW-1L 334 is ON. Also, the limiting current value of the CHG-IC 302 is the current value I1, and the lighting pattern of the LED 372 is the lighting pattern P1 (step S104; step S105).

In the case where the output voltage VBAT of the battery 320 is greater than or equal to VTH2, the CPU 304 starts up and bus enumeration is performed. If the enumeration state is Configured, the NO_CHG_OUT4 signal is L and the SW-1L 334 is OFF. Also, the limiting current value of the CHG-IC 302 is the current value I2, and the lighting pattern of the LED 372 is the lighting pattern P2 (step S125; step S126). If the enumeration state is Suspended, the NO_CHG_OUT4 signal is H and the SW-1L 334 is ON. Also, the limiting current value of the CHG-IC 302 is the current value I4, and the lighting pattern of the LED 372 is the lighting pattern P4 (step S123; step S124).

Next, the case where the USB connection destination detection information in the truth table of FIG. 2 is Available will be described. In the case where the voltage VBATT of the battery 320 is less than VTH2, the CPU 304 has not yet started up and the USB connection destination detection information is not referenced. Therefore, the NO_CHG_OUT4 signal is L and the SW-1L 334 is ON. Also, the limiting current value of the CHG-IC 302 is the current value I1, and the lighting pattern of the LED 372 is the lighting pattern P1 (step S104; step S105). In the case where the output voltage VBATT of the battery 320 is greater than or equal to VTH2, the CPU 304 starts up and the USB connection destination detection information is referenced. The NO_CHG_OUT4 signal is L and the SW-1L 334 is OFF. Since charging of the battery 320 is then performed under the current value limitation of the USB connection destination detection information, the limiting current value of the CHG-IC 302 is the current value I3, and the lighting pattern of the LED 372 is the lighting pattern P3 (step S115; step S116).

According to the first embodiment, as described above, in the case where the voltage of the secondary battery of the electronic device is less than a threshold value, a charge condition (where the limiting current value is given as the current value I1) is determined regardless of the USB connection destination detection result of the external device, and display (lighting pattern P1) corresponding thereto is performed. Thus, display identifying that charging is being performed in a state where enumeration has not been implemented is possible, and the user is able to grasp this. Also, in the case where the voltage of the secondary battery of the electronic device is greater than or equal to the threshold value, a charge condition is determined based on the USB connection destination detection result of the external device and/or the enumeration result, and display in accordance with the charge condition is performed. The electronic device determines a charge condition at which the limiting current value will be the current value I4 which is less than or equal to the current value I1, in the case where a USB connection destination detection result cannot be obtained from the external device, or in the case where the enumeration result is not Configured. In other words, the electronic device, in the case where it is determined that the power supply capability of the external device cannot be confirmed, determines a charge condition at which the limiting current value will be the current value I4 which is less than or equal to the current value I1. The electronic device then lights the LED 372 with the lighting pattern P4. Accordingly, display reflecting the USB connection destination detection result and the result of enumeration is performed, and the user is able to easily identify whether charging is being performed normally.

### Second Embodiment

In the abovementioned first embodiment, in the case where the voltage of the secondary battery of the electronic device is less than a threshold value, a charge condition is determined regardless of the USB connection destination detection result of the external device, and display identifying this is performed. Also, in the case where the voltage of the secondary battery of the electronic device is greater than or equal to the threshold value, a charge condition is determined based on the USB connection destination detection result of the external device and/or the enumeration result, and notification capable of identifying the determined charge condition is performed.

In contrast, in a second embodiment that will be described below, a charge condition is determined based on the USB connection destination detection result of the external device in the case where the voltage of the secondary battery of the electronic device is less than a threshold value, and display that enables the determined charge condition to be identified is performed. Also, in the case where the voltage of the secondary battery of the electronic device is greater than or equal to the threshold value, a charge condition is determined based on the USB connection destination detection result of the external device and/or the enumeration result, and display in accordance with the determined charge condition is performed.

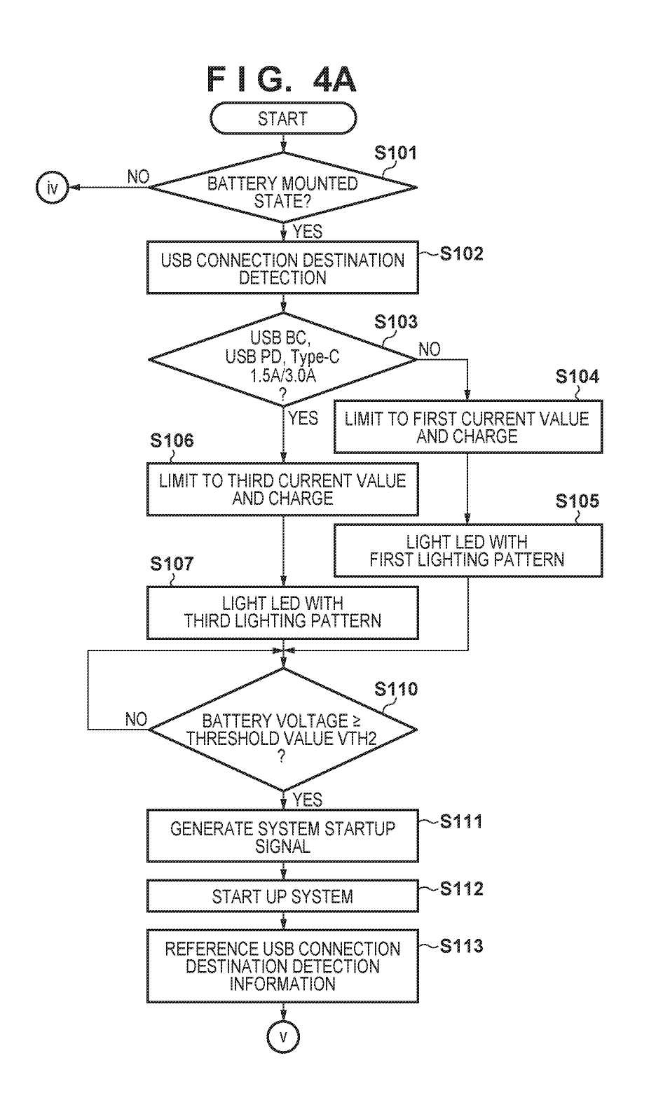

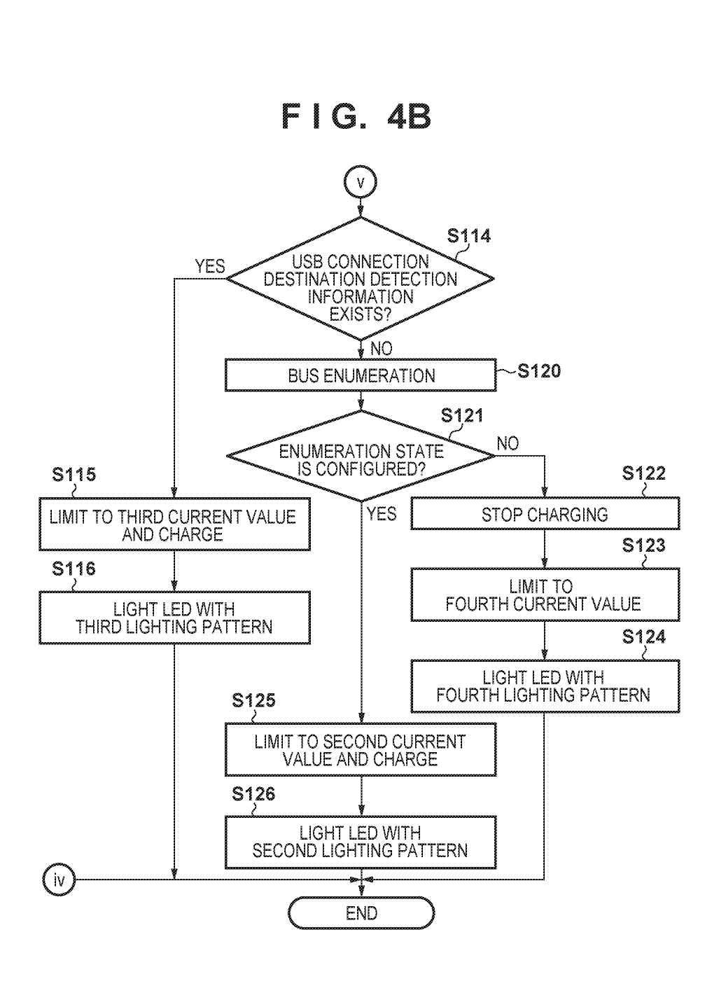

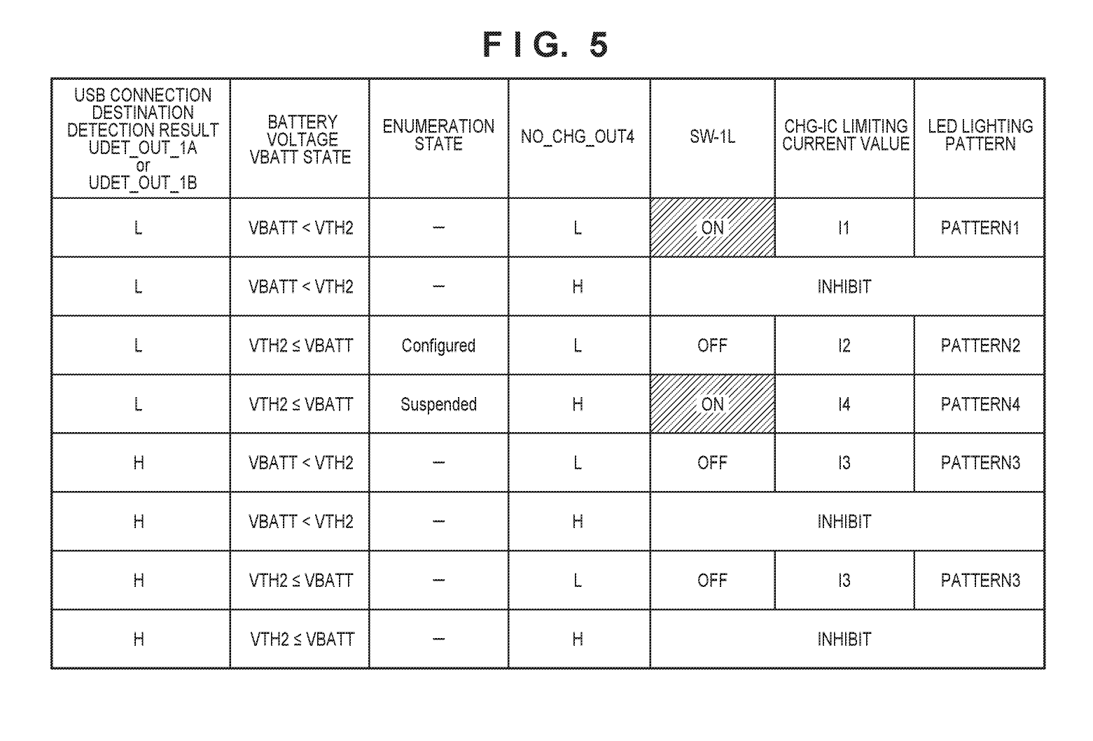

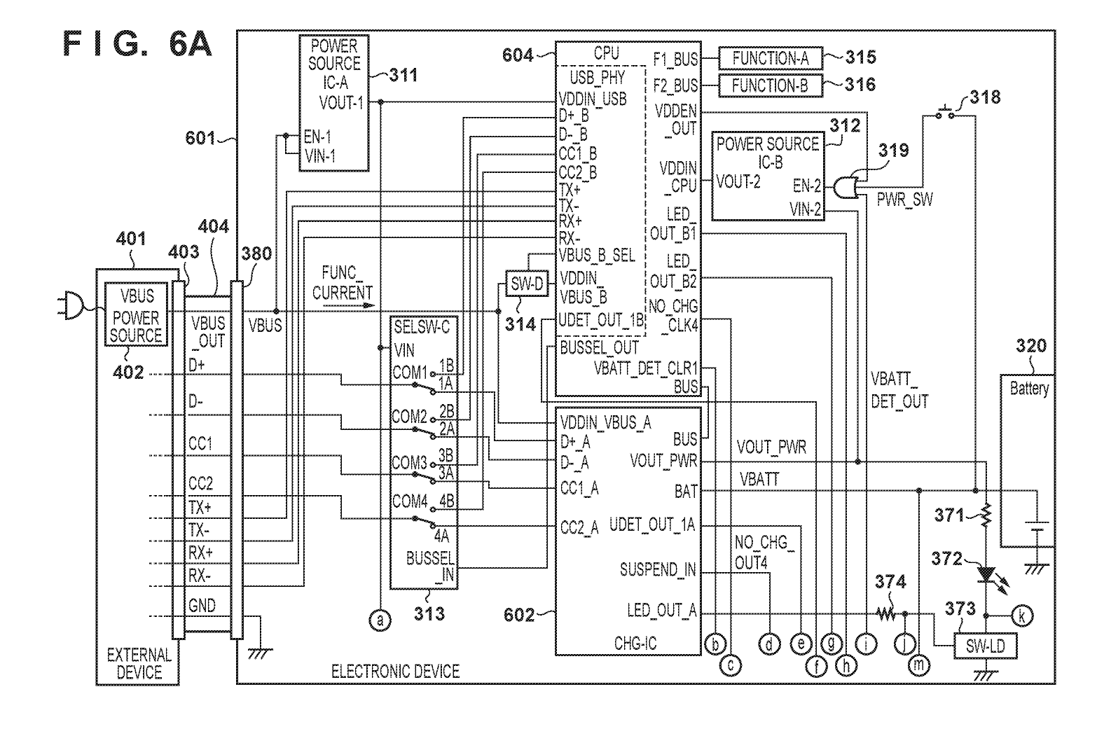

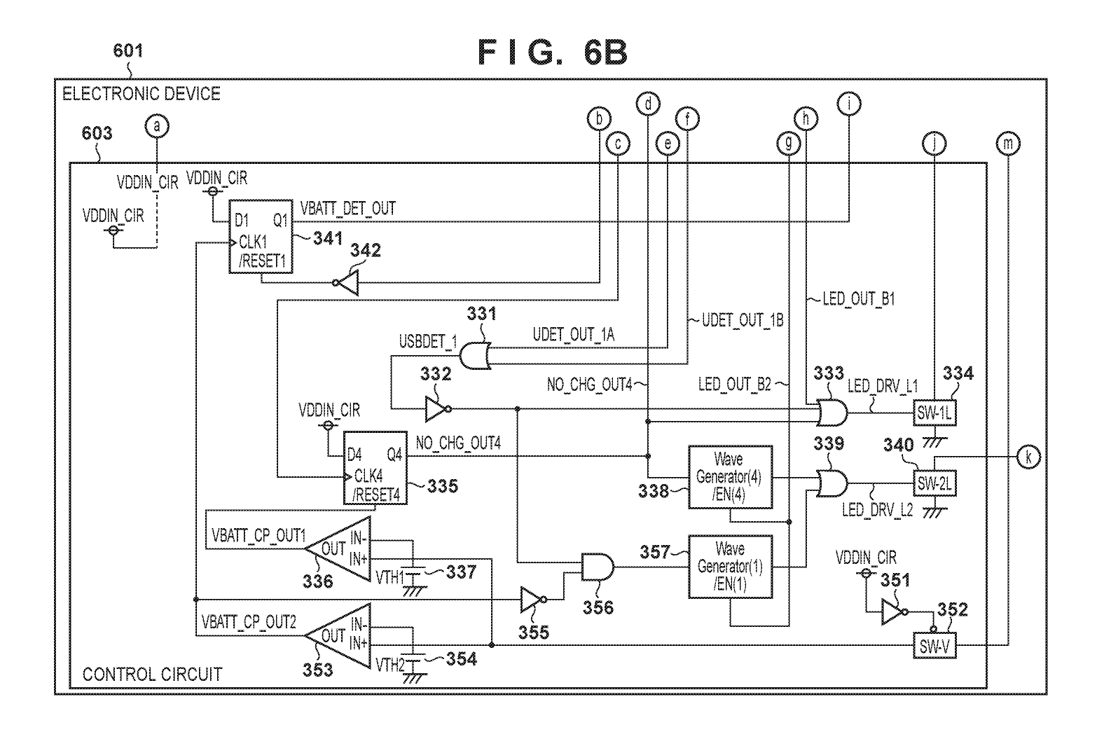

FIGS. 4A and 4B are flowcharts showing processing for determination of a charge condition and display of a charge state in the electronic device of the second embodiment. FIG. 5 is a truth table showing the correspondence between connection destination detection results, output voltages of the secondary battery, charge conditions (limiting current values) and display patterns (LED lighting patterns) in the second embodiment. FIG. 6A and FIG. 6B are block diagrams showing an exemplary configuration of the electronic device according to the second embodiment. First, the configuration of the electronic device according to the second embodiment will be described using FIG. 6A and FIG. 6B. Note that, in FIG. 6A and FIG. 6B, illustration regarding configuration that is unnecessary in the description of the present embodiment has been omitted. Also, in FIG. 6A and FIG. 6B, the same reference signs are given to constituent elements that are the same or similar to the configuration (FIG. 3A, FIG. 3B) of the first embodiment. Hereinafter, in order to avoid redundancy of description as much as possible, the description will focus on the differences from the first embodiment.

In an electronic device 601 of FIG. 6A and FIG. 6B, a CPU 604 is capable of outputting a USB connection destination detection result as a UDET_OUT_1B signal. Also, a CHG-IC 602 is capable of outputting a USB connection destination detection result as a UDET_OUT_1A signal. In the second embodiment, the CHG-IC 602 executes USB connection destination detection, and outputs UDET_OUT_1A at H in the case where a USB connection destination is detected, and outputs UDET_OUT_1A at L in the case where a USB connection destination cannot be detected. Also, the CPU 604 executes USB connection destination detection, and outputs UDET_OUT_1B at H in the case where a USB connection destination is detected, and outputs UDET_OUT_1B at L in the case where a USB connection destination cannot be detected. Note that the USB connection destination detection function in the second embodiment is similar to the first embodiment.

UDET_OUT_1B of the CPU 604 and UDET_OUT_1A of the CHG-IC 602 are connected to an OR 331 of a control circuit 603. The output (USBDET_1) of the OR 331 is supplied to an inverter 332. The output of the inverter 332 is connected to an OR 333 and an AND 356. The output of the inverter 332 and the output of an inverter 355 are connected to the input of the AND 356. The output of the inverter 332, a NO_CHG_OUT4 signal and a LED_OUT_B1 signal of the CPU 604 are connected to the input of the OR 333.

The output of the AND 356 is connected to a WaveGenerator 357. In the first embodiment, the LED_DRV_L1 signal, which is the output of the OR 333, was determined by the OR of three inputs consisting of the output of the inverter 355, the NO_CHG_OUT4 signal and the LED_OUT_B1 signal of the CPU 304. In contrast, in the second embodiment, the LED_DRV_L1 signal is determined by the OR of three inputs consisting of the output (inversion signal of USBDET_1) of the inverter 332, the NO_CHG_OUT4 signal and the LED_OUT_B1 signal of the CPU 604.

The difference between the circuits that determine output of the LED_DRV_L1 signal, in the configuration of the first embodiment and the configuration of the second embodiment, will be further described. In the first embodiment, the detection result of whether the voltage of the battery 320 is greater than or equal to the threshold value VTH2 is used in output determination of the LED_DRV_L1 signal. In contrast, in the second embodiment, the USB connection destination detection result (USBDET_1) is used instead of the detection result of whether the voltage of the battery 320 is greater than or equal to the threshold value VTH2, in output determination of the LED_DRV_L1 signal.

Also, in the first embodiment, the WaveGenerator 357 is driven by the output of the inverter 355, whereas in the second embodiment, the WaveGenerator 357 is driven with AND output of two inputs consisting of the output of the inverter 332 and the output of the inverter 355. More specifically, in the first embodiment, detection of whether the voltage of the battery 320 is greater than or equal to the threshold value VTH2 is used in control of the WaveGenerator 357. In contrast, in the second embodiment, AND output of the detection of whether the voltage of the battery 320 is greater than or equal to the threshold value VTH2 and the USB connection destination detection result is used in control of the WaveGenerator 357.

Hereinabove, the configuration of the electronic device 601 of the second embodiment was described. FIGS. 4A and 4B are flowcharts showing an example of the procedure for the electronic device 601 according to the second embodiment to perform USB connection destination detection and start charging the battery 320. Although USB connection destination detection is possible with either the CHG-IC 602 or the CPU 604, in the second embodiment description will be given with USB connection destination detection being performed by the CHG-IC 602. Note that, in the flowcharts of FIGS. 4A and 4B, the same reference signs are given to processing that is the same or similar to the flowcharts (FIGS. 1A and 1B) shown in the first embodiment. Hereinafter, the description will focus on the differences from the first embodiment.

When the battery is in a mounted state and an external device 401 is connected to a USB connector 380, the CHG-IC 602 executes USB connection destination detection (YES at step S101; step S102). The CHG-IC 602 then determines whether the external device 401 that is connected is a USB BC, USB PD or 1.5 A or 3.0 A USB Type-C compatible apparatus, based on the result of USB connection destination detection (step S103). When it is determined that the external device 401 is a compatible apparatus (YES at step S103), the CHG-IC 602 outputs the UDET_OUT_1A signal at H as a state in which there is a USB connection destination detection result. The CHG-IC 602 then sets the limiting current value to the current value I3 and starts charging the battery 320 (step S106). Note that although the current value I3 is given as 0.5 A, the current value I3 is not limited to 0.5 A, and may be any current value that does not exceed the current value that is supported by the USB connection power transmission apparatus, in accordance with the result of USB connection destination detection information.

In the present embodiment, as described above, the initial state of the CHG-IC 602 is a setting for determining the limiting current value depending on the USB connection destination partner apparatus and charging the battery. Note that the limiting current value and the charge setting are changeable under control of the CPU 604 that uses communication using the BUS.

Also, the CHG-IC 602 lights the LED 372 with the lighting pattern P3 and displays the charge state (step S107). The lighting pattern P3 is realized as a result of the CHG-IC 602 controlling a LED_OUT_A signal. The lighting pattern in the case where the external device 401 that is connected is a USB BC, USB PD or 1.5 A or 3.0 A USB Type-C compatible apparatus is set in advance in the CHG-IC 602 as the lighting pattern P3. Note that, in this case, since UDET_OUT_1A changes to H, the WaveGenerator 357 that provides the lighting pattern P1 is not operating.

On the other hand, in the case where the external device 401 is not a USB BC, USB PD, or 1.5 A or 3.0 A USB Type-C compatible apparatus or where the connection destination is unknown (NO at step S103), step S104 is executed. Step S104 is also executed in the case where the external device 401 is an SDP (Standard Downstream Port).

First, the CHG-IC 602 outputs the UDET_OUT_1A signal at L as a state in which there is not a USB connection destination detection result, and sets the limiting current value to the current value I1 and starts charging the battery 320 (step S104). The control circuit 603 displays that the charge state is a charge state in which the limiting current value is set to the current value I1 by lighting the LED 372 with the lighting pattern P1 (step S105). Note that, with the lighting pattern P1, the LED 372 is lighted/extinguished with the signal pattern that is output from the WaveGenerator 357 of the control circuit 603, as a result of the UDET_OUT_1A signal changing to L.

Because the other processing of the flowcharts of FIGS. 4A and 4B according to the present embodiment is similar to the processing (flowcharts of FIGS. 1A and 1B) described in the first embodiment, description thereof is omitted. FIG. 5 is a truth table showing limiting current values and lighting patterns of the LED 372 corresponding to the USB connection destination detection information of the electronic device 601, the voltage VBATT state of the battery 320, the enumeration state, the NO_CHG_OUT4 signal and the state of the SW-1L 334. The notations INHIBIT, Configured and Suspended are similar to the first embodiment (FIG. 2).

First, the case where the USB connection destination detection result of the truth table of FIG. 5 is L (the case where the external device is other than a compatible apparatus) will be described. Since the CPU 604 has not yet started up and bus enumeration has not been performed in the case where the output voltage VBATT of the battery 320 is less than VTH2, the enumeration state is BLANK. The NO_CHG_OUT4 signal is L, the SW-1L 334 is ON, the limiting current value of the CHG-IC 602 is the current value I1, and the lighting pattern of the LED 372 is the lighting pattern P1.

When the output voltage VBATT of the battery 320 is greater than or equal to VTH2, the CPU 604 starts up and the USB connection destination detection information is referenced, and since the USB connection destination detection information is L, bus enumeration is executed. If the enumeration state is Configured, the NO_CHG_OUT4 signal is L and the SW-1L 334 is OFF. Also, the limiting current value of the CHG-IC 602 is the current value I2, and the lighting pattern of the LED 372 is the lighting pattern P2. On the other hand, if the enumeration state is Suspended, the NO_CHG_OUT4 signal is H and the SW-1L 334 is ON. Also, the limiting current value of the CHG-IC 602 is the current value I4, and the lighting pattern of the LED 372 is the lighting pattern P4.

Next, the case where the USB connection destination detection result of the truth table of FIG. 5 is H will be described. In the case where output voltage VBATT of the battery 320 is less than VTH2, the CPU 604 has not yet started up and USB connection destination detection information has not been referenced, but the USB connection destination detection result is H. Accordingly, the NO_CHG_OUT4 signal is L and the SW-1L 334 is OFF. Since charging of the battery 320 is performed under the current value limitation of the USB connection destination detection information, the limiting current value of the CHG-IC 602 is the current value I3, and the lighting pattern of the LED 372 is the lighting pattern P3.

When the output voltage VBATT of the battery 320 is greater than or equal to VTH2, the CPU 604 starts up and the USB connection destination detection information is referenced. The USB connection destination detection result is H, the NO_CHG_OUT4 signal is L, and the SW-1L 334 is OFF. Accordingly, since charging of the battery 320 is performed under the current value limitation of the USB connection destination detection information, the limiting current value of the CHG-IC 602 is set to the current value I3, and the lighting pattern of the LED 372 is the lighting pattern P3.

According to the second embodiment, as described above, in the case where the voltage of the secondary battery of the electronic device is less than a threshold value, a charge condition is determined based on the USB connection destination detection result of the external device that is connected, and display that enables the determined charge condition to be identified is performed. Thus, if there is a USB connection destination detection result even in a state where enumeration has not been implemented, a charge condition that is based on the current supply capability of the external device is set, and it is possible to charge the secondary battery with a higher current. Also, the user is able to identify through display that such charging is being performed.

Also, according to the second embodiment, in the case where the voltage of the secondary battery of the electronic device is greater than or equal to the threshold value, a charge condition is determined based on the USB connection destination detection result of the external device and/or the enumeration result, and display that enables the determined charge condition to be identified is performed. Thus, the USB connection destination detection result and the result of enumeration are reflected, and whether or not charging is being performed normally is displayed to the user in an intelligible manner.

### Third Embodiment

In the abovementioned first embodiment and second embodiment, methods for performing charging of the secondary battery and display based on the USB connection destination detection result and/or the enumeration result were described. In a third embodiment, the secondary battery is provided with an authentication IC for guaranteeing that the battery is an exclusively designed battery with suitable charging characteristics, and a configuration in which an electronic device utilizes this authentication IC will be described. The electronic device of the third embodiment:
in the case where the voltage of the secondary battery is less than a threshold value, determines a charge condition based on the USB connection destination detection result of the external device that is connected and the authentication result of the secondary battery, and performs display in accordance with the charge condition, and
in the case where the voltage of the secondary battery is greater than or equal to the threshold value, determines a charge condition based on the authentication result of the secondary battery in addition to the USB connection destination detection result of the external device and/or the enumeration result, and performs display in accordance with the determined charge condition.

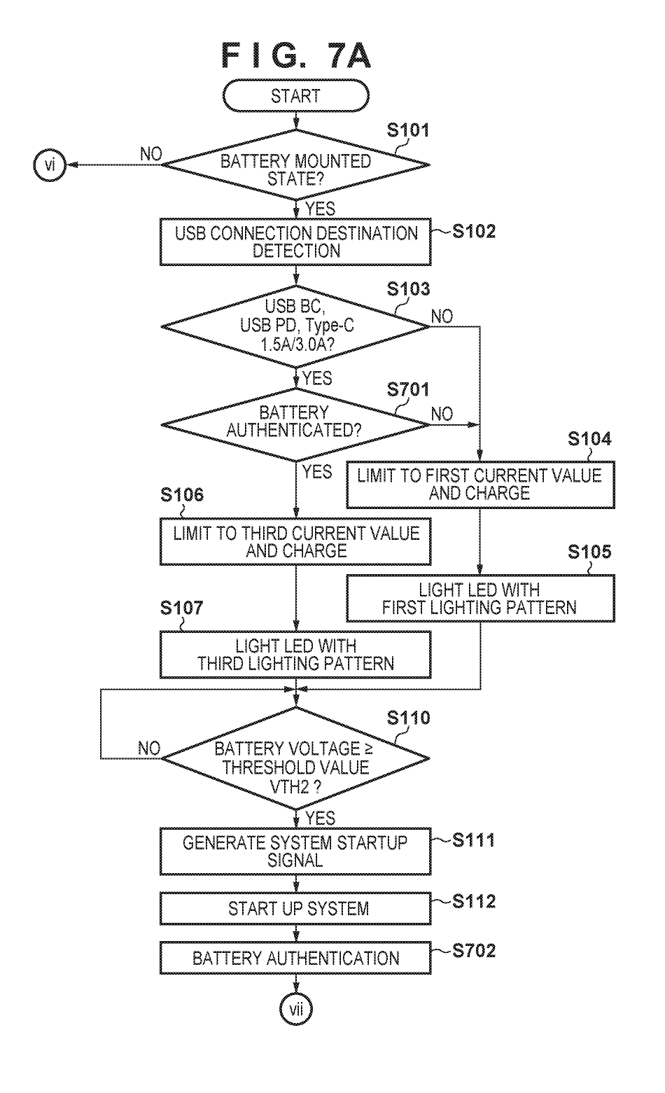

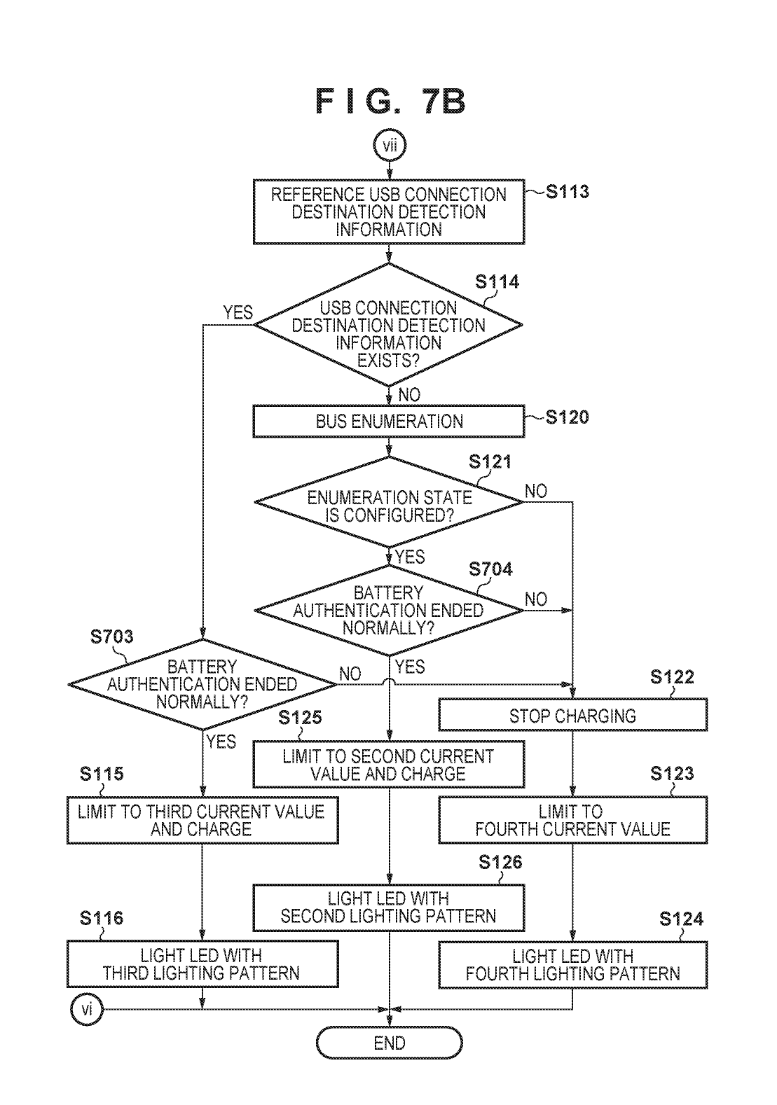

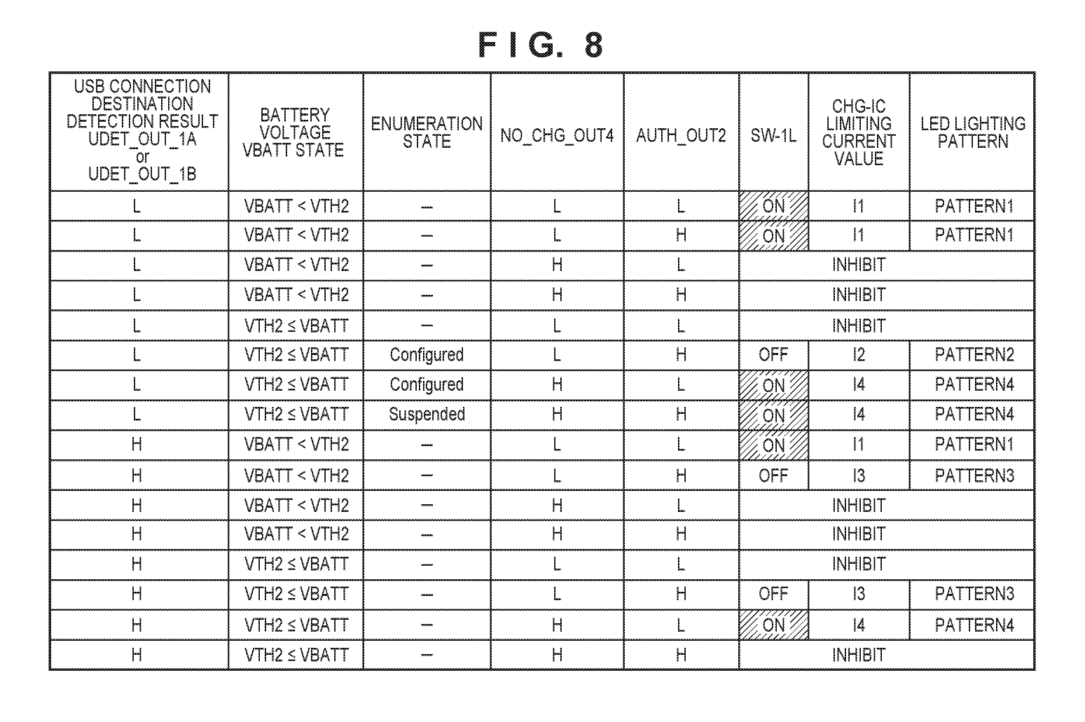

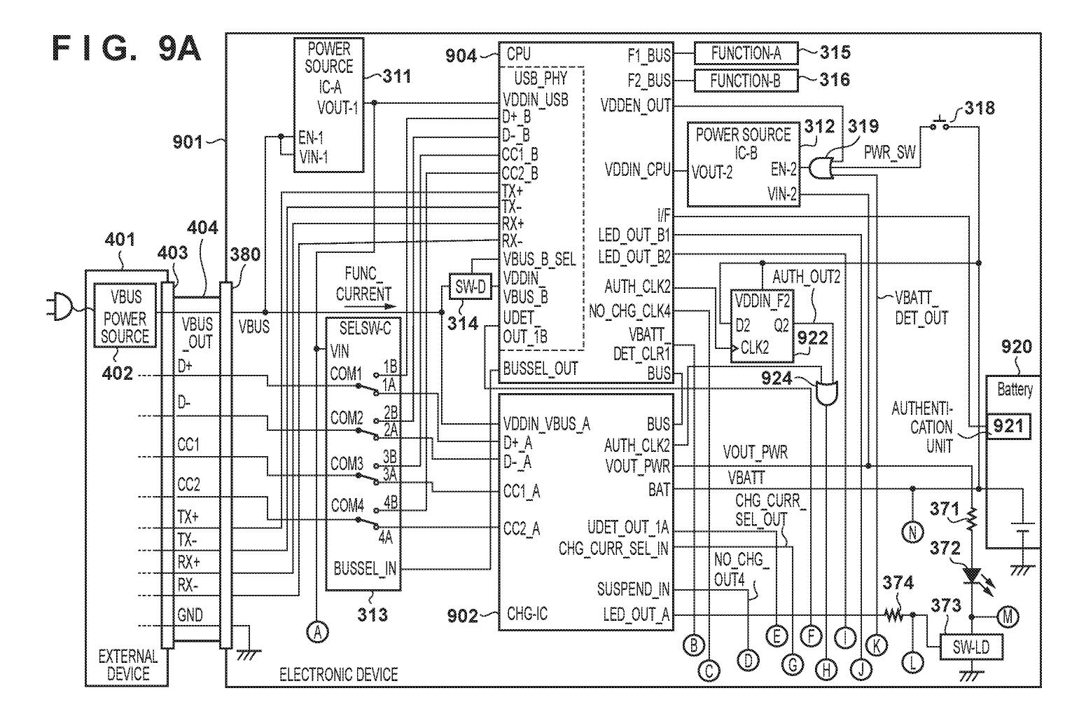

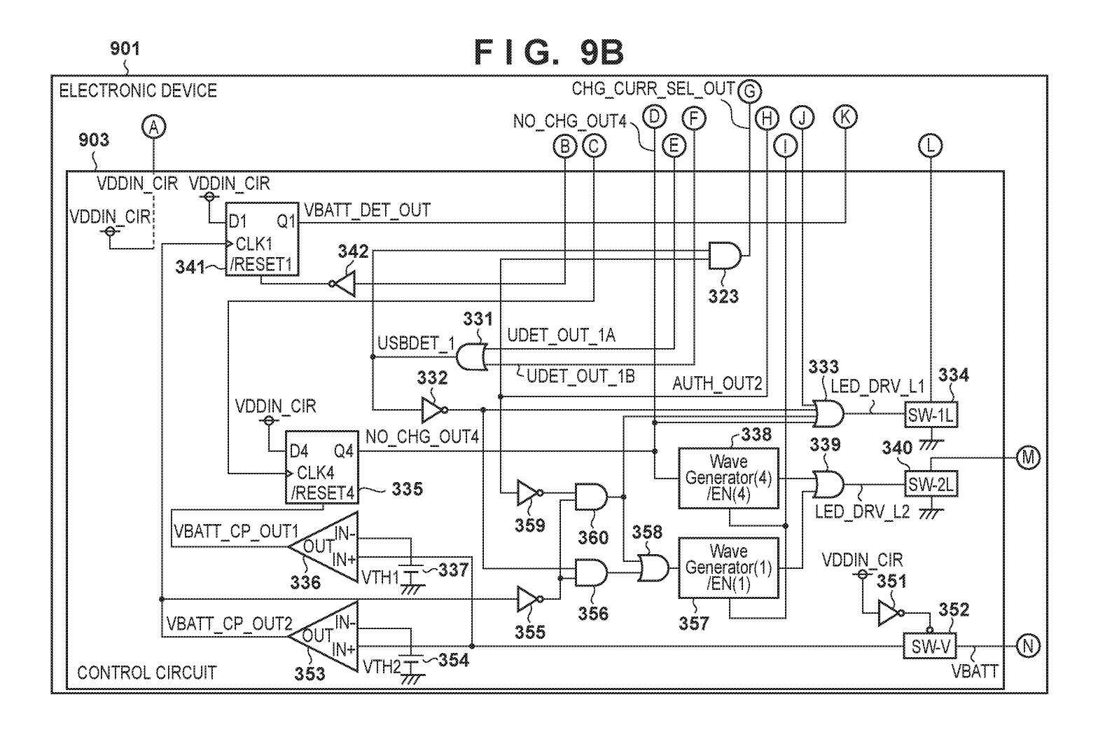

FIGS. 7A and 7B are flowcharts showing processing for determination of a charge condition and display of a charge state by the electronic device of the third embodiment. FIG. 8 is a truth table showing the correspondence between connection destination detection results, output voltages of the secondary battery, charge conditions (limiting current values) and display patterns (LED lighting patterns). FIG. 9A and FIG. 9B are block diagrams showing an exemplary configuration of the electronic device according to the third embodiment. First, the configuration of the electronic device according to the third embodiment will be described using FIG. 9A and FIG. 9B. Note that, in FIG. 9A and FIG. 9B, illustration regarding configuration that is unnecessary in the description of the present embodiment has been omitted. Also, in FIG. 9A and FIG. 9B, the same reference signs are given to constituent elements that are the same or similar to the configuration (FIG. 6A, FIG. 6B) of the second embodiment. Hereinafter, the description will focus on the differences from the second embodiment.

The electronic device 901 is provided, within the same casing as a battery 920, with an authentication unit 921 for guaranteeing that the battery is an exclusively designed battery suited to the charging characteristics of the battery 920. A CPU 904 of the electronic device 901 connects to the authentication unit 921 of the battery 920 with an I/F, and performs authentication with the authentication unit 921. In the case where the authentication unit 921 could be normally authenticated, the CPU 904 performs control so as to perform charging with a current value suited to the charging characteristics of the battery 920. Also, in the case where the authentication unit 921 could not be normally authenticated, the CPU 904 stops charging the battery 920 for safety reasons.

Note that, in the third embodiment, description is given with charging of the battery 920 being stopped for safety reasons, in the case where the electronic device 901 could not perform authentication normally, but the response in the case where authentication could not be performed normally is not limited thereto. For example, a configuration may be adopted in which the electronic device 901, in the case where it could not perform authentication normally, limits the charge current value of the battery 920 to a safe value and performs charging.

A power source VDDIN_F2 and a D2 input of a D-FF 922 are connected to VBATT. An AUTH_CLK2 output of the CPU 904 is connected to a CLK2 input of D-FF 922. The initial value of the AUTH_CLK2 output of the CPU 904 is given as L. A Q2 output (AUTH_OUT2) of the D-FF 922 is supplied to an inverter 359 and an AND 323 of a control circuit 903, via an OR 924. The CPU 904 notifies the authentication result of the authentication unit 921 to a CHG-IC 902 via the BUS, and the CHG-IC 902 holds the notified authentication result in a register. The CHG-IC 902 outputs H in the case where the authentication result being held to the register indicates that authentication was successful. AUTH_CLK2 of the CHG-IC 902 is also supplied to the inverter 359 and the AND 323 of the control circuit 903 via the OR 924.

Note that, in the case where the power source VDDIN_F2 of the D-FF 922 falls, storage information becomes volatile and the D-FF 922 transits to an initial value. Also, in the case where the battery 920 is removed, the CPU 904 notifies erasure of the authentication result to the CHG-IC 902 via the BUS, and the CHG-IC 902 erases the authentication result being held in the register.

In the control circuit 903, the AUTH_OUT2 signal and a USBDET_1 signal are connected to the input of the AND 323. Also, the output (CHG_CURR_SEL_OUT) of the AND 323 is connected to CHG_CURR_SEL_IN of the CHG-IC 902. CHG_CURR_SEL_IN of the CHG-IC 902 is used in charge current control of the CHG-IC 902. The CHG-IC 902 sets the charge current of the battery 920 to less than 0.1 A in the case where CHG_CURR_SEL_IN is L, and sets the charge current of the battery 920 to less than 0.5 A in the case where CHG_CURR_SEL_IN is H.

The CPU 904 outputs AUTH_CLK2 at H and thereafter at L, in the case where authentication is performed with the authentication unit 921 and the authentication unit 921 could be authenticated normally. The Q2 output (AUTH_OUT2 signal) of the D-FF 922 thereby transits from L to H. In the case where the AUTH_OUT2 signal is H and the USBDET_1 signal is H, that is, the authentication unit 921 is normally authenticated and a USB connection destination is detected, the CHG_CURR_SEL_OUT signal, which is the output of the AND 323, transits to H. When the CHG_CURR_SEL_OUT signal transits to H, that is, when CHG_CURR_SEL_IN of the CHG-IC 902 transits to H, the CHG-IC 902 changes the current value limitation of the VBUS from 0.1 A to 0.5 A and charges the battery 920.

Even if the AUTH_OUT2 signal is H, the CHG_CURR_SEL_OUT signal transits to L, in the case where the USBDET_1 signal is L, that is, the authentication unit 921 is normally authenticated, but a USB connection destination cannot be detected. The CHG_CURR_SEL_OUT signal is output at L, in the case where the AUTH_OUT2 signal is L and the USBDET_1 signal is H, or similarly in the case where the AUTH_OUT2 signal is L and the USBDET_1 signal is L. As a result of the CHG_CURR_SEL_OUT signal being output at L, the charge current of the battery 920 by the CHG-IC 902 is controlled to be less than 0.1 A.

The output (inversion signal of AUTH_OUT2) of the inverter 359 is connected to an AND 360. The output (inversion signal of VBATT_CP_PUT2) of the inverter 355 is connected to an AND 356 and the AND 360. The output of the AND 360 is connected to an OR 333 and an OR 358. The output of the AND 356 is connected to the OR 358. The output of the OR 358 is connected to the WaveGenerator 357.

The output of the AND 360, the output of the inverter 332, a NO_CHG_OUT4 signal and a LED_OUT_B1 signal of the CPU 904 are connected to the input of the OR 333. In the second embodiment (FIG. 6B), a LED_DRV_L1 signal, which is the output of the OR 333, was determined by the OR of three inputs consisting of the output of the inverter 332, the NO_CHG_OUT4 signal and the LED_OUT_B1 signal of the CPU 604. In contrast, in the third embodiment (FIG. 9B), the LED_DRV_L1 signal is determined by the OR of four inputs consisting of the output of the AND 360, the output of the inverter 332, the NO_CHG_OUT4 signal and the LED_OUT_B1 signal of the CPU 904.

The difference between the circuits for determining output of the LED_DRV_L1 signal in the second embodiment and the third embodiment will be further described. In the second embodiment, detection of whether the voltage of the battery 320 is greater than or equal to the threshold value VTH2 and the USB connection destination detection result are used in output determination of the LED_DRV_L1 signal. In contrast, in the third embodiment, the authentication result of the authentication unit 921 of the battery 920 is used, in addition to detection of whether the voltage of the battery 920 is greater than or equal to the threshold value VTH2 and the USB connection destination detection result, in output determination of the LED_DRV_L1 signal.

Also, the difference between the circuits for determining driving of the WaveGenerator 357 in the second embodiment and the third embodiment will be further described. In the second embodiment (FIG. 6B), the WaveGenerator 357 is driven with the output of the AND 356. In contrast, in the third embodiment (FIG. 9B), the WaveGenerator 357 is driven by the OR of two inputs consisting of the output of the AND 360 and the output of the AND 356. In the second embodiment (FIG. 6B), determination that combines detection of whether the voltage of the battery 320 is greater than or equal to the threshold value VTH2 and the USB connection destination detection result is used in the control determination of the WaveGenerator 357. In contrast, in the third embodiment (FIG. 9B), determination that combines detection of whether the voltage of the battery 920 is greater than or equal to the threshold value VTH2, the USB connection destination detection result, and the authentication result of the authentication unit 921 of the battery 920 is used in the control determination of the WaveGenerator 357.

Hereinabove, the block diagrams of the electronic device 901 of FIGS. 9A and 9B were described. Next, using the flowcharts of FIGS. 7A and 7B, an example of the procedure for the electronic device 901 according to the third embodiment to perform USB connection destination detection and authentication processing of the authentication unit 921 of the battery 920 and start charging of the battery 920 will be described. Note that USB connection destination detection according to the third embodiment can be executed with either the CHG-IC 902 or the CPU 904. Hereinafter, description will be given with USB connection destination detection being performed by the CHG-IC 902. Also, in the flowcharts of FIGS. 7A and 7B, the same reference signs are given to processing that is the same or similar to the flowcharts (FIGS. 4A and 4B) of the second embodiment. Hereinafter, the description will focus on the differences from the second embodiment.

When the battery is in a mounted state and an external device 401 is connected to the USB connector 380, the CHG-IC 902 executes USB connection destination detection (YES at step S101; step S102). The CHG-IC 902 then determines whether the external device 401 that is connected is a USB BC, USB PD or 1.5 A or 3.0 A USB Type-C compatible apparatus, based on the result of USB connection destination detection (step S103). When it is determined that the external device 401 is a compatible apparatus (YES at step S103), the CHG-IC 902 determines whether the authentication unit 921 of the battery 920 has been authenticated (step S701). As described above, in the case where the register of the CHG-IC 902 holds the previous authentication result of the authentication unit 921 of the battery 920, and the authentication result that is held in the register indicates that authentication was ended normally (authentication was successful), AUTH_OUT2 changes to H. As a result, H is output from the OR 924 as the AUTH_OUT2 signal.

In the case where it is detected by USB connection destination detection that the external device 401 is a compatible apparatus, the CHG-IC 902 outputs a UDET_OUT_1A signal indicating a state in which there is a USB connection destination detection result at H. As a result, in the case of YES at step S701, the AUTH_OUT2 signal and the USBDET_1 signal transit to H, and thus the CHG_CURR_SEL_OUT signal transits to H, and the CHG-IC 902 starts charging the battery 920 with the limiting current value set to the current value I3 (step S104). Note that although the current value I3 is given as 0.5 A, the current value I3 is not limited to 0.5 A, and may be any current value that does not exceed the current value that is supported by the USB connection power transmission apparatus, in accordance with the result of USB connection destination detection information.

In the present embodiment, as described above, the initial state of the CHG-IC 902 is a setting for determining the limiting current value depending on the USB connection destination partner apparatus and charging the battery. Note that the value of the limiting current value and the charge setting are changeable under the control of the CPU 904 with communication using the BUS.

Next, the CHG-IC 902 lights the LED 372 with the lighting pattern P3 and displays the charge state (step S107). Similarly to the second embodiment, the lighting pattern P3 is realized as a result of the CHG-IC 902 controlling a LED_OUT_A signal.

On the other hand, in the case where, at step S103, the external device 401 that is connected is not a USB BC, USB PD or 1.5 A or 3.0 A USB Type-C compatible apparatus or where the connection destination is unknown or an SDP, step S104 is executed. In this case, UDET_OUT_1A and UDET_OUT_1B are L, and USBDET_1 is L. Also, in the case where, at step S701, it is determined that authentication of the authentication unit 921 of the battery 920 has not been performed or was previously not ended normally (in the case where the authentication result is not held in the register or authentication failure is held), AUTH_OUT2 transits to L, and step S104 is executed.

Since USBDET_1 or AUTH_OUT2 is L in the case where it is determined to be NO at step S103 or step S701 and step S104 is executed, the CHG_CURR_SEL_OUT signal transits to L. As a result, CHG_CURR_SEL_IN of the CHG-IC 902 transits to L, and the CHG-IC 902 starts charging the battery 920 with the limiting current value set to the current value I1. Here, the current value I1 is given as 0.1 A. The control circuit 603 then displays that the charge state is a charge state in which the limiting current value is set to the current value I1 by lighting the LED 372 with the lighting pattern P1 (step S105). Lighting/extinguishing of the LED 372 with the lighting pattern P1 is implemented by the WaveGenerator 357 of the control circuit 903.

Thereafter, the charge state determined as described above is maintained until the output voltage VBATT of the battery 320 becomes greater than or equal to the threshold value VTH2. When the output voltage VBATT of the battery 320 has become the threshold value VTH2, the control circuit 903 generates the system startup signal (step S111), and the system (main function of the CPU 904 in the present embodiment) starts up (step S112). Note that the VBATT_DET_OUT signal of the control circuit 903 is used in the system startup signal. In the system startup, the hardware and software of the CPU 904 start up, and the CPU 904 whose software has started up outputs a VDDEN_OUT signal and maintains the output of the power source IC-B 312. The VBATT_DET_OUT signal of the control circuit 903 is then reset with the VBATT_DET_CLR1 signal.

Next, the CPU 904 communicates with the authentication unit 921 of the battery 920 via an I/F, and performs authentication processing (step S702). The CPU 904 outputs the AUTH_CLK2 at H and thereafter at L in the case where authentication processing of the authentication unit 921 of the battery 920 was ended normally. The D-FF 922 thereby transits the AUTH_OUT2 signal from L to H, and maintains that state. Also, in the case where authentication processing of the authentication unit 921 of the battery 920 was not ended normally, the CPU 904 continues to output AUTH_CLK2 at L. Accordingly, the AUTH_OUT2 signal of the D-FF 922 will remain at L. Also, the CPU 904 notifies the authentication result to the CHG-IC 902 via the BUS, and the CHG-IC 902 holds the notified authentication result in the register.

The CPU 904 references the USB connection destination detection information detected at step S102 (step S113). Referencing the USB connection destination detection information is performed by the CPU 904 obtaining the USB connection destination detection information from the CHG-IC 902 with communication using the BUS. In the case where USB connection destination detection information exists (YES at step S114), and authentication processing of the authentication unit 921 of the battery 920 is normal (YES at step S703), the CHG-IC 302 sets the limiting current value to the current value I3 and charges the battery 320 (step S115). The CPU 304 then performs control such that the LED 372 is lighted with the lighting pattern P3 to display the charge state (step S117). In the case where authentication processing of the authentication unit 921 of the battery 920 has not ended normally (NO at step S703), the CPU 904 stops charging that is currently being executed on the battery 920 (step S122).

Also, in the case where USB connection destination detection information does not exist (NO at step S114), enumeration is executed (step S120). In the case where the result of enumeration indicates that the state is Configured, the CPU 904 determines whether authentication processing of the authentication unit 921 of the battery 920 was normal (step S704). In the case where it is determined that the authentication result is normal, the CHG-IC 302 continues charging the battery 320 with the limiting current value set to the current value I2 (YES at step S704; step S125), and lights the LED 372 with the lighting pattern P2 (step S126). On the other hand, in the case where authentication processing of the authentication unit 921 of the battery 920 was not ended normally, charging of the battery 920 is stopped (step S122). Because other portions of the flowcharts of FIGS. 7A and 7B according to the third embodiment are similar to the flowcharts of FIGS. 4A and 4B described in the second embodiment, description thereof is omitted.

The truth table of FIG. 8 shows the limiting current value of the CHG-IC 902 and the lighting pattern of the LED 372 corresponding to the USB connection destination detection result of the electronic device 901, the voltage VBATT state of the battery 920, the enumeration state, the NO_CHG_OUT4 signal, the AUTH_OUT2 signal, and the state of the SW-1L 334. The notations INHIBIT, Configured and Suspended are similar to the second embodiment (FIG. 5).

First, the case where the USB connection destination detection result of the truth table of FIG. 8 is L will be described. Since the CPU 904 has not yet started up and bus enumeration has not been performed in the case where the output voltage VBATT of the battery 920 is less than VTH2, the enumeration state is BLANK. In this case, the NO_CHG_OUT4 signal will be L and the SW-1L 334 will be ON. Also, regardless of the AUTH_OUT2 signal, the limiting current value of the CHG-IC 902 is the current value I1, and the lighting pattern of the LED 372 is the lighting pattern P1.

When the voltage VBATT of the battery 920 is greater than or equal to VTH2, the CPU 904 starts up and authentication processing with the authentication unit 921 of the battery 920 and bus enumeration is performed. In the case where authentication processing of the authentication unit 921 ended normally as a result of having performed authentication processing with the authentication unit 921 of the battery 920, the AUTH_OUT2 signal is H, and in the case where authentication processing of the authentication unit 921 did not end normally, the AUTH_OUT2 signal is L. If authentication processing of the authentication unit 921 of the battery 920 ends normally and the enumeration state is Configured, the NO_CHG_OUT4 signal is L, the AUTH_OUT2 signal is H, and the SW-1L 334 is OFF. In this case, the limiting current value of the CHG-IC 902 is the current value I2, and the lighting pattern of the LED 372 is the lighting pattern P2.

If authentication processing of the authentication unit 921 of the battery 920 does not end normally and the enumeration state is Configured, the NO_CHG_OUT4 signal is H, the AUTH_OUT2 signal is L, and the SW-1L 334 is ON. Also, the limiting current value of the CHG-IC 902 is the current value I4 and the lighting pattern of the LED 372 is the lighting pattern P4. In the case where authentication processing of the authentication unit 921 of the battery 920 ends normally and the enumeration state is Suspended, the NO_CHG_OUT4 signal will be H, the AUTH_OUT2 signal will be H, and the SW-1L 334 will be ON. The limiting current value of the CHG-IC 902 will then be the current value I4, and the lighting pattern of the LED 372 will be the lighting pattern P4.

Next, the case where the USB connection destination detection result is H in the truth table of FIG. 8 will be described. In the case where the voltage VBATT of the battery 920 is less than VTH2, the CPU 904 has not yet started up and the USB connection destination detection information has not been referenced, but the USB connection destination detection result is H. In the case where authentication processing of the authentication unit 921 of the battery 920 has previously not ended normally, the NO_CHG_OUT4 signal is L, the AUTH_OUT2 signal is L, and the SW-1L 334 is ON. Also, the limiting current value of the CHG-IC 902 will be the current value I1, and the lighting pattern of the LED 372 will be the lighting pattern P1. In the case where authentication processing of the authentication unit 921 of the battery 920 has previously ended normally, the NO_CHG_OUT4 signal is L, the AUTH_OUT2 signal is H, and the SW-1L 334 is OFF. Since charging of the battery 920 is performed under the current value limitation of the USB connection destination detection information, the limiting current value of the CHG-IC 902 will be the current value I3, and the lighting pattern of the LED 372 will be the lighting pattern P3.

When the output voltage VBATT of the battery 920 is greater than or equal to VTH2, the CPU 904 starts up and performs authentication processing with the authentication unit 921 of the battery 920, and references the USB connection destination detection information. Here, the USB connection destination detection result is H. In the case where authentication processing of the authentication unit 921 of the battery 920 is ended normally, the NO_CHG_OUT4 signal will be L, the AUTH_OUT2 signal will be H, and the SW-1L 334 will be OFF. Since charging of the battery 920 is performed under the current value limitation of the USB connection destination detection information, the limiting current value of the CHG-IC 902 will be the current value I3, and the lighting pattern of the LED 372 will be the lighting pattern P3. In the case where authentication processing of the authentication unit 921 of the battery 920 did not ended normally, the NO_CHG_OUT4 signal will be H, the AUTH_OUT2 signal will be L, and the SW-1L 334 will be ON. Also, the limiting current value of the CHG-IC 902 will be the current value I4, and the lighting pattern of the LED 372 will be the lighting pattern P4.

According to the third embodiment, as described above, in the case where the voltage of the secondary battery of the electronic device is less than a threshold value, a charge condition is determined based on the USB connection destination detection result of the external device and the authentication result of the secondary battery, and display that enables the determined charge condition to be identified is performed. Thus, if there is a USB connection destination detection result and an authentication result of the secondary battery even in a state where enumeration has not been implemented, a charge condition based on the current supply capability of the external device can be determined, and the secondary battery can be charged with a higher current. Furthermore, the user is able to easily identify that such charging is being performed.

Also, according to the third embodiment, when the voltage of the secondary battery of the electronic device becomes greater than or equal to a threshold value, a charge condition is redetermined based on the authentication result of the secondary battery and the USB connection destination detection result of the external device and/or the enumeration result. The electronic device charges the secondary battery under the redetermined charge condition, and performs display that enables the charge state to be identified. Thus, the user is able to easily grasp whether charging that reflects the USB connection destination detection result, the authentication result of the secondary battery and the result of enumeration is being executed normally.

### Fourth Embodiment

In the first to third embodiments, exemplary configurations in which a control circuit for performing display at the time of charging the battery of an electronic device is operated with hardware sequence control were described. However, it is also possible to realize part of the operations of the control circuit using a processor that executes a predetermined program. In the fourth embodiment, performing part of the operations of the control circuit 903 of the electronic device described in the third embodiment with software sequence control using a different CPU (hereinafter, SUB-CPU) from the CPU 904 will be described.

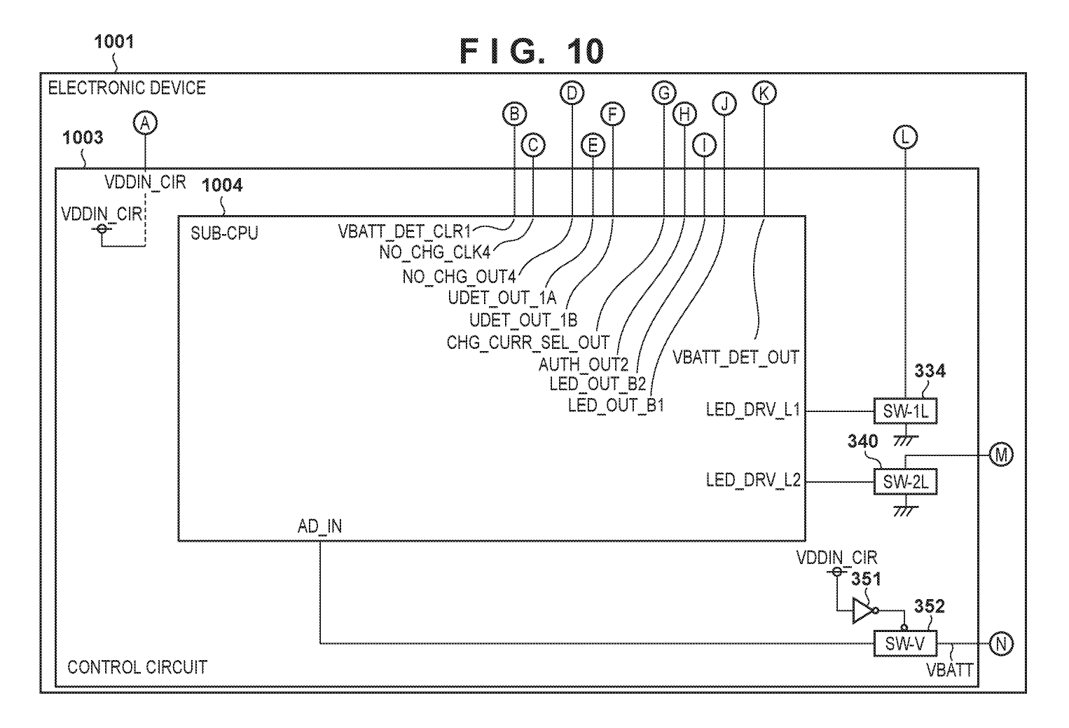

The configuration of an electronic device according to the fourth embodiment is represented using FIG. 9A and FIG. 10. FIG. 10 is a block diagram in which an exemplary configuration of a control circuit 1003 out of the configuration of an electronic device 1001 according to the fourth embodiment is shown in detail. In FIG. 10, power source connections to unnecessary blocks are omitted from the description of the fourth embodiment. Also, a detailed description of blocks and operations that are unnecessary in the description of the present embodiment has been omitted.

In FIG. 10, a SUB-CPU 1004 compatibly operates, as software sequence control, part of the control circuit 903 that constitutes part of the sequence control described in FIGS. 7A and 7B of the third embodiment. The SUB-CPU 1004 is a different CPU from the CPU 904. Also, in FIG. 10, the control circuit 1003 is a control circuit that performs display at the time of charging the battery of the electronic device 1001, and includes the SUB-CPU 1004 in part thereof. The control circuit 1003 shown in FIG. 10 and the control circuit 903 of the electronic device 901 described with FIG. 9B of the third embodiment perform similar operations from the perspective of the CPU 904 and the CHG-IC 902.

A configuration is given in which the power source of the SUB-CPU 1004 is obtained from the same output VOUT-1 of the power source IC-A 311 as the power source VDDIN_CIR of the entire control circuit 1003, and in which power is constantly supplied in the case where the VBUS of the power transmission apparatus is connected. In the case where supply is started from a state where the power source VDDIN_CIR of the entire control circuit 1003 is not supplied, the logic of the SUB-CPU 1004 is given as being set to an initial state to negate the functions thereof. Also, the functions of the SUB-CPU 1004 are negated, in the case where supply is ended from a state where the power source VDDIN_CIR of the entire control circuit 1003 is supplied.

The SUB-CPU 1004 may receive input of a USB connection destination detection result from either the CPU 904 or the CHG-IC 902. The USB connection destination detection result of the CPU 904 is output from UDET_OUT_1B of the CPU 904, and input to the SUB-CPU 1004. The USB connection destination detection result of the CHG-IC 902 is output from UDET_OUT_1A of the CHG-IC 902, and input to the SUB-CPU 1004. The LED_OUT_B1 signal, the LED_OUT_B2 signal, the NO_CHG_CLK3 signal and the VBATT_DET_CLR1 signal that are output from the CPU 904, and the AUTH_OUT2 signal that is output from the D-FF 922 are input to the SUB-CPU 1004. The voltage VBATT of the battery 920 that is output via the SW-V 352 is input to AD IN of the SUB-CPU 1004.

The VBATT_DET_OUT signal that is output from the SUB-CPU 1004 is connected to the input of the OR 319. The NO_CHG_OUT4 signal that is output from the SUB-CPU 1004 is input to SUSPEND_IN of the CHG-IC 902, and the CHG_CURR_SEL_OUT signal is input to CHG_CURR_SEL_IN of the CHG-IC 902. The LED_DRV_L1 signal and the LED_DRV_L2 signal that are output from the SUB-CPU 1004 are respectively connected to the input of the SW-1L 334 and the SW-2L 340.

In the control circuit 1003 of the electronic device 1001 of FIG. 10 according to the fourth embodiment, a portion excluding the part of the hardware circuit operation of the control circuit 903 in the electronic device 901 of FIG. 9B that is replaced with the software control of the SUB-CPU 1004 performs similar operations. Therefore, the procedure for the electronic device 1001 according to the fourth embodiment to perform USB connection destination detection and authentication processing of the authentication unit 921 of the battery 920 and start charging the battery 920 will be the procedure shown by the flowcharts of FIGS. 7A and 7B of the third embodiment. In the case of applying the flowcharts of FIGS. 7A and 7B, the operating condition in the control circuit 1003 according to the fourth embodiment will be that shown in the truth table of FIG. 8.

According to the fourth embodiment as described above, the control circuit that performs display at the time of charging the battery of the electronic device is realized with software sequence control rather than hardware sequence control. According to the fourth embodiment, it is possible to perform charging of the secondary battery and display based on USB connection destination detection and the authentication processing result of the authentication unit 921 of the battery 920 by software sequence control.

Note that although, in the fourth embodiment, part of the control circuit 903 shown in the third embodiment (FIG. 9B) is replaced with a SUB-CPU, such a configuration is also applicable to the control circuit 303 of the first embodiment (FIG. 3B) or the control circuit 603 of the third embodiment (FIG. 6B). That is, it is also possible to replace part of hardware circuit operation of the control circuit 303 or the control circuit 603 with software control of the SUB-CPU 1004. Therefore, it is also possible for the electronic device 1001 according to the fourth embodiment to operate so as to realize the processing of the flowcharts (FIGS. 1A and 1B) of the first embodiment or the flowcharts (FIGS. 4A and 4B) of the second embodiment. In the case of applying the flowcharts of FIGS. 1A and 1B, the truth table of FIG. 2 is applied to the example of the operating condition in the control circuit 1003 according to the present embodiment. In the case of applying the flowcharts of FIGS. 4A and 4B, the truth table of FIG. 5 is applied to the example of the operating condition in the control circuit 1003 according to the present embodiment.

### OTHER EMBODIMENTS

In the first to fourth embodiments, description was given taking, as an example, use of 1 bit of USBDET_1 as a signal with which the control circuit determines the USB connection destination detection result. However, the signal for determining the USB connection destination detection result is not limited to 1 bit. For example, a configuration may also be adopted in which the signal for determining the USB connection destination detection result is converted to a multi-value signal to increase the types of applicable USB connection destinations. In that case, a configuration may also be adopted so as to support the following standards, depending on the USB connection destination detection result, for example. Because 14 types of USB connection destinations can be determined in the following case, 4 bits will be required. The OR 331 obtains USBDET_1 by outputting the OR of a signal consisting of these 4 bits. For example, in the case where connection destination detection is performed by the CHG-IC 302, UDET_OUT_1A will be a 4-bit signal, and a configuration for notifying the detection result (type) to the CPU 904 will be required.

Apparatus supporting USB BC standard up to 5 V/1.5 A: current value I3 set to 1.5 A.

Apparatus supporting 1.5 A current mode of USB Type-C connector: current value I3 set to 1.5 A.

Apparatus supporting 3.0 A current mode of USB Type-C connector: current value I3 set to 3.0 A.

Apparatus supporting 5 V/2.0 A output of USB PD standard PROFILE 1: current value I3 set to 2.0 A.

Apparatus supporting 5 V/2.0 A output of USB PD standard PROFILE 2: current value I3 set to 2.0 A.

Apparatus supporting 12 V/1.5 A output of USB PD standard PROFILE 2: current value I3 set to 1.5 A.

Apparatus supporting 5 V/2.0 A output of USB PD standard PROFILE 3: current value I3 set to 2.0 A.

Apparatus supporting 12 V/3.0 A output of USB PD standard PROFILE 3: current value I3 set to 3.0 A.

Apparatus supporting 5 V/2.0 A output of USB PD standard PROFILE 4: current value I3 set to 2.0 A.

Apparatus supporting 12 V/3.0 A output of USB PD standard PROFILE 4: current value I3 set to 3.0 A.

Apparatus supporting 20 V/3.0 A output of USB PD standard PROFILE 4: current value I3 set to 3.0 A.

Apparatus supporting 5 V/2.0 A output of USB PD standard PROFILE 5: current value I3 set to 2.0 A.

Apparatus supporting 12 V/5.0 A output of USB PD standard PROFILE 5: current value I3 set to 5.0 A.

Apparatus supporting 20 V/5.0 A output of USB PD standard PROFILE 5: current value I3 set to 5.0 A.

Also, although, in the first to fourth embodiments, description was given taking, as an example, performing signal transfer of control with the CPU and the CHG-IC with parallel signals, the signals to which the present invention is applicable are not limited to the parallel signals. For example, a configuration may also be adopted in which signal transfer of control with the CPU and the CHG-IC is performed with serial signals. In that case, general-purpose serial communication standards for two lines, three lines or the like may be used as serial signals.

In the first to fourth embodiments, LED lighting patterns for displaying charge states were described, taking the lighting patterns P1 to P4 as an example. These lighting patterns are not limited to all being different patterns, and the same lighting pattern may be applied to a number of the lighting patterns P1 to P4. For example, a configuration may be adopted in which the lighting pattern does not change in the case of continuing charging from before to after system startup of step S112 in the flowcharts of FIG. 1A, FIG. 4A and FIG. 7A. For example, the lighting pattern P1 and the lighting pattern P2 may be set as the same lighting pattern. Also, the lighting pattern P2 and the lighting pattern P3 may be set as the same lighting pattern. Similarly, the lighting pattern P1, the lighting pattern P2 and the lighting pattern P3 may be set as the same lighting pattern. In this case, the charge state is displayed with the lighting pattern P1, the lighting pattern P2 and the lighting pattern P3 set as the same lighting pattern, and it is also displayed that the charge state is not the charge state expected or that charging has been stopped by setting the lighting pattern P4 as a different lighting pattern therefrom.

Although, in the flowcharts showing examples of the procedure for starting battery charging from the first embodiment to the fourth embodiment, description was given according to the charge state before and after system startup of step S112, but it is not necessary to implement all of these. For example, a configuration may be adopted in which step S112 in the flowcharts showing examples of the procedure for starting battery charge is divided into before system startup and after system startup, and either thereof is implemented. Also, the abovementioned current value I2 that is set at step S125 and current value I3 that is set at step S106 and step S115 may be equal. The case where Configured is obtained as a result of enumeration is the case where it is confirmed that the required current value is obtained from the external device. Accordingly, the current value I3, which is a limiting current value in the case where it is confirmed that the required current value is obtained by USB connection destination detection, and the current value I2, which is the limiting current value in the case where Configured is confirmed, can be set to the same current value that is required by the electronic device.

Also, in the flowcharts showing examples of the procedure for starting battery charging from the first embodiment to the fourth embodiment, methods for lighting an LED that displays the charge state at steps S126 and S124 were described. However, the LED lighting timing for displaying charge states to which the present invention is applicable is not limited to steps S126 and S124. For example, in steps S126 and S124, a pattern for lighting the LED may be merely set, and the LED need not be lighted at the point in time at which steps S126 and S124 are executed.

In that case, when the CPU of the electronic device starts the system at step S112 and starts software operation, the LED_OUT_B2 signal is controlled to be H, and signal output of the WaveGenerator 357 and the WaveGenerator 338 is controlled to be invalidated. Also, display that depends on the pattern set as described above is performed by display drive of the FUNCTION-B 316, for example. When the CPU ends software operation, controls the VDDEN_OUT signal to be L and ends the system, the LED_OUT_B2 signal transits from H to L. As a result, the signal output of the WaveGenerator 357 and the WaveGenerator 338 of the control circuit are validated, and it becomes possible to perform charge state display with the LED whose lighting pattern is set.

Although, in the first to fourth embodiments, description was given taking, as an example, a configuration in which the LED for displaying the charge state has one light, the configuration for displaying charge states to which the present invention is applicable is not limited to a configuration in which the LED has one light. For example, display of charge states is possible even using a display apparatus other than an LED, and a configuration for displaying the charge state of the present invention is possible even if the LED has two lights. In that case, a configuration may be adopted in which independently controllable LEDs are respectively provided in the CHG-IC and the control circuit to enable the charge state to be shown in greater detail.

Note that although, in the above, lighting patterns realized by lighting/extinguishing an LED were used for notification of the charge state, the present invention is not limited thereto. For example, means such as the emission colors of LEDs or sounds issued by a buzzer or the like may be used. That is, the lighting patterns described in the embodiments are one example of notifying patterns for notifying the charge state.

In the first to third embodiments, using a hardware circuit as an example of a control circuit was described as an example, and in the fourth embodiment, using a CPU in part thereof as an example of a control circuit was described as an example. However, examples of a control circuit to which the present invention is applicable are not limited to only a hardware circuit or a CPU. For example, the present invention is applicable even if a reconfigurable IC such as a FPGA (Field-Programmable Gate Array) or a PLD (Programmable Logic Device) is used. Also, the present invention is applicable even if a non-reconfigurable IC such as an ASIC (Application Specific Integrated Circuit) is used.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-164062, filed Aug. 24, 2016, which is hereby incorporated by reference herein in its entirety.

What is claimed is:

1. An electronic device configured to be connected to an external device and to charge a secondary battery using power supplied from the external device, comprising:
a determination unit configured to determine whether the external device has a predetermined power supply capability;
a charge control unit configured to receive power from the external device at a predetermined current value and charge the secondary battery, in a case where it is determined that the external device has the predetermined power supply capability; and
a notification unit configured to notify a charge state of the secondary battery with a first notifying pattern, before it is determined whether the external device has the predetermined power supply capability, and to notify the charge state with a second notifying pattern corresponding to determining that the external device has the predetermined power supply capability.

2. The electronic device according to claim 1,
wherein the notification unit notifies the charge state with the first notifying pattern, after the electronic device connects the external device and before it is determined whether the external device has the predetermined power supply capability by the determining unit.

3. The electronic device according to claim 1,
wherein the notification unit notifies with different pattern from the first notifying pattern in a case where the electronic device is not connected to the external device.

4. The electronic device according to claim 1,
wherein the charge control unit receives power from the external device at a first current value that is lower than the predetermined current value and charges the secondary battery, before it is determined whether the external device has the predetermined power supply capability.

5. The electronic device according to claim 4,
wherein the notification unit notifies the charge state with the first notifying pattern, in response to power being received from the external device at the first current value and charging of the secondary battery being started.

6. The electronic device according to claim 1,
wherein the determination unit determines whether the external device has the predetermined power supply capability corresponding to the electronic device connecting to the external device.

7. The electronic device according to claim 1,
wherein the determination unit determines whether the external device has the predetermined power supply capability, in a case where a voltage of the secondary battery is greater than or equal to a predetermined voltage.

8. The electronic device according to claim 1,
wherein, in a case where it is determined that the external device does not have the predetermined power supply capability, the charge control unit receives power from the external device at a second current value that is less than or equal to the first current value and charges the secondary battery, and the notification unit notifies the charge state with a third notifying pattern.

9. The electronic device according to claim 8,
wherein the second current value is equal to the first current value.

10. The electronic device according to claim 6, further comprising:
a second determination unit configured to determine whether the secondary battery is an authenticated battery,
wherein, in a case where the secondary battery is not the authenticated battery, the notification unit notifies the charge state with the third notifying pattern.

11. The electronic device according to claim 1,
wherein, in a case where it is determined that the external device does not have the predetermined power supply capability, the charge control unit does not charge the secondary battery.

12. The electronic device according to claim 1,
wherein the determination unit includes:
a logic detection unit configured to logically detect whether the external device supports a predetermined USB standard; and
a communication determination unit configured to communicate with the external device and determine the power supply capability that the external device has, in a case where the logic detection unit determines that the external device does not support the predetermined USB standard,
in a case where the logic detection unit detects that the external device supports the predetermined USB standard, the charge control unit receives power from the external device at a third current value corresponding to the predetermined USB standard and charges the secondary battery, and the notification unit notifies the charge state with the second notifying pattern, and
in response to the communication determination unit having communicated with the external device and determined the power supply capability that the external device has, the charge control unit receives power from the external device at a fourth current value that depends on the determined power supply capability that the external device has and charges the secondary battery, and the notification unit notifies the charge state with the second notifying pattern.

13. The electronic device according to claim 1,
wherein the determination unit, in a case where the external device supports any of USB standards including USB 2.0, USB 3.0, USB 3.1, USB Battery Charger, USB Power Delivery and USB Type-C, determines that the external device supports the predetermined power supply capability.

14. The electronic device according to claim 13,
wherein the charge control unit receives power from the external device at a current value that depends on the USB standard that the external device supports.

15. A control method for an electronic device configured to be connected to an external device and to charge a secondary battery using power supplied from the external device, the method comprising:
determining whether the external device has a predetermined power supply capability;
receiving power from the external device at a predetermined current value and charging the secondary battery, in a case where it is determined that the external device has the predetermined power supply capability; and
notifying a charge state of the secondary battery with a first notifying pattern, before it is determined whether the external device has the predetermined power supply capability, and notifying the charge state with a second notifying pattern corresponding to determining that the external device has the predetermined power supply capability.

16. The method according to claim 15, wherein the charge state is notified with the first notifying pattern, after the electronic device connects the external device and before it is determined whether the external device has the predetermined power supply capability.

17. The method according to claim 15,
wherein a notification is performed with a notifying pattern different from the first notifying pattern in a case where the electronic device is not connected to the external device.

18. The method according to claim 15, further comprising:
receiving power from the external device at a first current value that is lower than the predetermined current value and charging the secondary battery, before it is determined whether the external device has the predetermined power supply capability.

19. The method according to claim 18, further comprising:
notifying the charge state with the first notifying pattern, in response to power being received from the external device at the first current value and charging of the secondary battery being started.

20. The method according to claim 15,
wherein whether the external device has the predetermined power supply capability is determined corresponding to the electronic device connecting to the external device.

21. The method according to claim 15,
wherein the determination of whether the external device has the predetermined power supply capability is executed in a case where a voltage of the secondary battery is greater than or equal to a predetermined voltage.

22. The method according to claim 15, further comprising:
in a case where it is determined that the external device does not have the predetermined power supply capability, receiving power from the external device at a second current value that is less than or equal to the first current value and charging the secondary battery, and notifying the charge state with a third notifying pattern.

23. The method according to claim 22,
wherein the second current value is equal to the first current value.

24. The method according to claim 20, further comprising:
determining whether the secondary battery is an authenticated battery,
wherein in a case where the secondary battery is not the authenticated battery, the charge state is notified with the third notifying pattern.

25. The method according to claim 15,
wherein, in a case where it is determined that the external device does not have the predetermined power supply capability, the secondary battery is not charged.

26. The method according to claim 15,
wherein determining whether the external device has the predetermined power supply capability includes:
logically detecting whether the external device supports a predetermined USB standard; and
communicating with the external device and determining the power supply capability that the external device has, in a case where it is determined by the logical detection that the external device does not support the predetermined USB standard, and
the method further comprises:
in a case where it is detected by the logical detection that the external device supports the predetermined USB standard, receiving power from the external device at a third current value corresponding to the predetermined USB standard and charging the secondary battery, and notifying the charge state with the second notifying pattern, and
in a case where the power supply capability that the external device has is determined by communication with the external device, receiving power from the external device at a fourth current value that depends on the determined power supply capability that the external device has and charging the secondary battery, and notifying the charge state with the second notifying pattern.

27. The method according to claim 15,
wherein, in a case where the external device supports any of USB standards including USB 2.0, USB 3.0, USB 3.1, USB Battery Charger, USB Power Delivery and USB Type-C, it is determined that the external device supports the predetermined power supply capability.

28. The method according to claim 27, further comprising:
receiving power from the external device at a current value that depends on the USB standard that the external device supports.

29. A non-transitory computer-readable medium storing a computer program, the computer program causing a computer of an electronic device configured to be connected to an external device and to charge a secondary battery using power supplied from the external device to execute a method including:
determining whether the external device has a predetermined power supply capability;
receiving power from the external device at a predetermined current value and charging the secondary battery, in a case where it is determined that the external device has the predetermined power supply capability; and
notifying a charge state of the secondary battery with a first notifying pattern, before it is determined whether the external device has the predetermined power supply capability, and notifying the charge state with a second notifying pattern corresponding to determining that the external device has the predetermined power supply capability.
